(19) United States
(12) Patent Application Publication
(10) Pub. No.: US 2023/0418466 A1
(43) Pub. Date: Dec. 28, 2023

(54) KEYBOARD MAPPED GRAPHICAL USER INTERFACE SYSTEMS AND METHODS

(71) Applicant: EMMANUEL PROULX, KANATA (CA)

(72) Inventor: EMMANUEL PROULX, KANATA (CA)

(21) Appl. No.: 18/250,247

(22) PCT Filed: Oct. 6, 2021
(86) PCT No.: PCT/CA2021/051397

§ 371 Date: Apr. 24, 2023

Related U.S. Application Data
(60) Provisional application No. 63/105,510, filed on Oct. 26, 2020.

(51) Int. Cl. G06F 3/0489; G06F 3/023; G06T 11/60; G06F 3/04886

(52) U.S. Cl. CPC G06F 3/0489; G06F 3/023; G06T 2200/24; G06F 3/04886; G06T 11/60

(57) ABSTRACT

Prior art graphical user interfaces with pointing devices require that actions the user wishes to perform must be serially established. Further, the use of a pointing device is not always feasible. Accordingly, it would be beneficial to provide users with a keyboard driven GUI interface allowing the user to perform actions normally reserved for pointing device driven GUI interfaces through the physical keyboard forming part of or associated with their electronic device or through a virtual keyboard forming part of another device to the device they are employing. Beneficially, embodiments of the invention support multiple concurrent actions by the user which may be associated with a single or multiple software applications. The template mapping the physical or virtual keyboard and an optional rendering of the template upon the GUI may be dynamically established or predetermined.

### CROSS-REFERENCE TO RELATED APPLICATIONS

This application claims the benefit of priority from World Intellectual Property Office Patent Application PCT/CA2021/051397 filed Oct. 6, 20211 which itself claims the benefit of priority from U.S. Provisional Patent Application 63/105,510 filed Oct. 26, 2020; the entire contents of each being incorporated herein by reference.

### FIELD OF THE INVENTION

This patent application relates to input interfaces and more particularly to employing a keyboard as an input interface supporting functionalities associated with other input interfaces as well as multiple concurrent actions by a user of the keyboard.

### BACKGROUND OF THE INVENTION

It is common to use a pointing device such as a mouse, touchpad, trackball, joystick, etc., in conjunction with a microprocessor based system rendering content to a user to click on objects on a computer screen and/or graphical user interface (“GUI”) and for software in execution upon the microprocessor based system to interpret the actions and act upon them, one object at a time. By their nature, these pointing devices only allow clicking on a single GUI object at a time.

Accordingly, prior art GUI interfaces with pointing devices requires moving a pointer rendered on the screen across the screen to point overlapping an object on the screen, and the pushing of a button to act upon this object. Such an interface is by its inherent nature serial as user actions must be performed in series. In many instances, a first GUI element may trigger a new screen to be displayed overlaying a second GUI element the user wishes to access necessitating additional GUI related actions to access the second GUI element.

In other circumstances the use of a pointing device is not feasible, e.g. with a laptop sitting on public transport, when the battery in the pointing device is drained, etc. Whilst touchscreens are available for laptops these tend to be more expensive limiting their deployment but they still require the manipulation of the pointer and actions in common with the same process as if the user were using a discrete pointing device, it is now their finger upon the touchscreen. Another circumstance where traditional pointing devices might be deficient is in the context of accessibility. For example, a user might have a disability affecting their fine motor skills, prohibiting them from using a computer mouse or a touchscreen (which are often quite delicate and unforgiving), but allowing them to use a keyboard (which is often sturdy and tolerant of jagged movements). Using the keyboard instead of the mouse could allow them to operate GUIs with more ease.

Accordingly, it would be beneficial to provide users with a keyboard driven GUI interface allowing the user to perform actions normally reserved for pointing device driven GUI interfaces. It would be further beneficial for such a keyboard driven GUI interface to support multiple concurrent actions by the user which may be associated with a single piece of software, e.g. an operating system such as Microsoft™ Windows or Apple™ macOS for example, or multiple pieces of software, e.g. software applications.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to input interfaces and more particularly to employing a keyboard as an input interface supporting functionalities associated with other input interfaces as well as multiple concurrent actions by a user of the keyboard.

In accordance with an embodiment of the invention there is provided a system comprising:
a display for rendering a graphical user interface (GUI) to a user;
a keyboard for receiving user inputs;
a microprocessor coupled to the display, the keyboard, and a non-transitory memory storing computer executable instructions for execution by the microprocessor; wherein
the computer executable instructions when executed by the microprocessor configure the microprocessor to execute a process comprising the steps of:
   establish an identity of the keyboard;
   retrieve a template associated with the identity of the keyboard, the template comprising a plurality of keyboard regions wherein each keyboard region of the plurality of keyboard regions is associated with a predetermined key or button of the keyboard;
   map each keyboard region of the plurality of keyboard regions to a screen portion of a plurality of screen portions, each screen portion of the plurality of screen portions associated with a predetermined portion of a GUI to be rendered upon the display to the user;
   establish content to be rendered within the GUI, the content associated with a software application which is either in execution upon the system or is in execution remotely through a web browser;
   render the content upon the display;
   detect a user action with respect to a key or button of the keyboard;
   perform an action with respect to a predetermined screen portion of the plurality of screen portions in dependence upon the key or button to which the user action relates and the template; wherein
the action is established in dependence upon the key or button to which the user action relates and the software application.

In accordance with an embodiment of the invention there is provided a system comprising:
a display for rendering a graphical user interface (GUI) to a user forming part of an electronic device;
a keyboard for receiving user inputs where the keyboard is rendered upon a touch sensitive display (another display) forming part of another electronic device;
a microprocessor coupled to the display, the keyboard, and a non-transitory memory storing computer executable instructions for execution by the microprocessor; wherein
the computer executable instructions when executed by the microprocessor configure the microprocessor to execute a process comprising the steps of:
   establish content to be rendered to a user within a GUI upon the display, the content associated with a software application which is either in execution upon at least one of the electronic device, the another electronic device and a remote application executing upon a remote server accessed through a web browser;
   establish a region of the content;
   establish a template, the template comprising a plurality of keyboard regions wherein each keyboard region of the plurality of keyboard regions is associated with a predetermined key or button of the keyboard;
   map each keyboard region of the plurality of keyboard regions to a screen portion of a plurality of screen portions, each screen portion of the plurality of screen portions associated with a predetermined portion of a GUI;
   render the template upon the display as an overlay to the established region of the content;
   render the template upon the another display;
   detect a user action with respect to a keyboard region of the plurality of keyboard regions of the keyboard;
   perform an action with respect to a predetermined screen portion of the plurality of screen portions in dependence upon the keyboard region of the plurality of keyboard regions to which the user action relates; and
   the action is established in dependence upon the keyboard region of the plurality of keyboard regions to which the user action relates and the software application.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary network environment within which configurable electrical devices according to and supporting embodiments of the invention may be deployed and operate; and

FIG. 2 depicts an exemplary wireless portable electronic device supporting communications to a network such as depicted in FIG. 1 and configurable electrical devices according to and supporting embodiments of the invention;

FIG. 3 depicts an exemplary screen of a game requiring a user to perform actions to progress within the game as may be employed within the prior art with a touch screen or mouse as an input interface for the user;

FIGS. 4A and 4B depict exemplary mappings of a screen displayed to a user to a keyboard allowing the user to employ the keyboard as an input interface according to an embodiment of the invention;

FIG. 4B depicts an exemplary mapping of a screen displayed to a user to a keyboard allowing the user to employ the keyboard as an input interface according to an embodiment of the invention;

FIG. 5 depicts exemplary mappings of a screen displayed to a user to a keyboard allowing the user to employ the keyboard as an input interface according to an embodiment of the invention;

FIG. 6 depicts exemplary partial mappings of screens displayed to a user to a keyboard allowing the user to employ the keyboard as an input interface according to an embodiment of the invention;

FIGS. 7A and 7B depict exemplary mappings of physical keyboards to a soft keyboard via a softboard to define regions of a GUI associated with the actions to be performed by the user through actions upon the physical keyboard;

FIG. 8A depicts exemplary mapping of a screen displayed to a user allowing the user to employ a keyboard as an input interface according to an embodiment of the invention wherein the displayed image on the screen is modified in dependence upon a softboard associated with the keyboard in use;

FIGS. 8B and 8C depict exemplary mapping of a screen displayed to a user allowing the user to employ a keyboard as an input interface according to an embodiment of the invention wherein the displayed image on the screen is modified in a magnified progression to allow selection of an element or icon where the number of these exceeds keys to map to or multiple icons are associated with a single key at an initial level;

FIGS. 9A and 9B depict exemplary mappings of portions of a screen displayed to a user to a keyboard allowing the user to employ the keyboard as an input interface according to an embodiment of the invention;

FIG. 10 depicts exemplary mapping of a pair of screens to a keyboard allowing the user to employ the keyboard as an input interface according to an embodiment of the invention;

FIG. 11 depicts exemplary images of automatically colour mapped keyboard overlays onto a screen allowing the user to employ the keyboard as an input interface according to an embodiment of the invention;

FIG. 12A depicts an exemplary image of concurrent or plesiochronous multiple keystroke input for multiple discrete actions with respect to a screen displayed to a user according to an embodiment of the invention;

FIG. 12B depicts an exemplary image of multiple keystroke input for multiple discrete actions with respect to a screen displayed to a user according to an embodiment of the invention;

FIGS. 13 to 15 depict exemplary user actions triggered by actions of a user with respect to a keyboard mapped to the screen according to an embodiment of the invention; and

FIGS. 16A and 16B depict exemplary non-standard keyboards which can be employed to allow a user to employ a keyboard as an input interface according to embodiments of the invention wherein the keyboard is mapped to the displayed image on the screen in dependence upon a softboard associated with the keyboard in use; and

FIGS. 17 to 20 depict exemplary mappings of a screen displayed to a user upon a head mounted display to a physical or virtual keyboard allowing the user to employ the keyboard as an input interface according to an embodiment of the invention.

### DETAILED DESCRIPTION

The present invention is directed to input interfaces and more particularly to employing a keyboard as an input interface supporting functionalities associated with other input interfaces as well as multiple concurrent actions by a user of the keyboard.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “wireless standard” as used herein and throughout this disclosure, refer to, but is not limited to, a standard for transmitting signals and/or data through electromagnetic radiation which may be optical, radio-frequency (RF) or microwave although typically RF wireless systems and techniques dominate. A wireless standard may be defined globally, nationally, or specific to an equipment manufacturer or set of equipment manufacturers. Dominant wireless standards at present include, but are not limited to IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, Bluetooth, Wi-Fi, Ultra-Wideband and WiMAX. Some standards may be a conglomeration of sub-standards such as IEEE 802.11 which may refer to, but is not limited to, IEEE 802.1a, IEEE 802.11b, IEEE 802.11g, or IEEE 802.11n as well as others under the IEEE 802.11 umbrella.

A “wired standard” as used herein and throughout this disclosure, generally refer to, but is not limited to, a standard for transmitting signals and/or data through an electrical cable discretely or in combination with another signal. Such wired standards may include, but are not limited to, digital subscriber loop (DSL), Dial-Up (exploiting the public switched telephone network (PSTN) to establish a connection to an Internet service provider (ISP)), Data Over Cable Service Interface Specification (DOCSIS), Ethernet, Gigabit home networking (G.hn), Integrated Services Digital Network (ISDN), Multimedia over Coax Alliance (MoCA), and Power Line Communication (PLC, wherein data is overlaid to AC/DC power supply). In some embodiments a “wired standard” may refer to, but is not limited to, exploiting an optical cable and optical interfaces such as within Passive Optical Networks (PONs) for example.

A “sensor” as used herein may refer to, but is not limited to, a transducer providing an electrical output generated in dependence upon a magnitude of a measure and selected from the group comprising, but is not limited to, environmental sensors, medical sensors, biological sensors, chemical sensors, ambient environment sensors, position sensors, motion sensors, thermal sensors, infrared sensors, visible sensors, RFID sensors, and medical testing and diagnosis devices.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

A “storage medium” as used herein, and throughout this disclosure, refers to one or more physical devices storing data in a non-transitory, non-volatile manner. A storage medium may include, but not be limited to, read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels and/or various other mediums capable of storing, containing or carrying instruction(s) and/or data.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the user engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, software systems, mechanical systems, robotic systems, android systems, etc. that may be characterised by an ability to exploit one or more embodiments of the invention. A user may also be associated through one or more accounts and/or profiles with one or more of a service provider, third party provider, enterprise, social network, social media etc. via a dashboard, web service, website, software plug-in, software application, and graphical user interface.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List_of_file_formats. Within a broader approach digital content mat include any type of digital information, e.g. digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “profile” as used herein, and throughout this disclosure, refers to a computer and/or microprocessor readable data file comprising data relating to settings and/or limits of an adult device. Such profiles may be established by a manufacturer/supplier/provider of a device, service, etc. or they may be established by a user through a user interface for a device, a service or a PED/FED in communication with a device, another device, a server or a service provider, etc.

An “input interface” as used herein, and throughout this disclosure, refers to a device exploiting the sense of touch by which a user interfaces with a PED and/or FED exploiting the input interface as a pointer and/or selector with respect to content rendered to a user upon a screen. Such input interfaces may include, but not be limited to, a computer mouse (mouse), a touch pad, a trackball, a game controller, a joystick, etc.

A “keyboard” as used herein, and throughout this disclosure, refers to a typewriter-style device which uses an arrangement of buttons or keys to act as mechanical levers or electronic switches. Such buttons or key may be physical buttons or keys or regions of a touchscreen or touch pad. In current usage, a keyboard is used as a text entry interface for typing text, numbers, and symbols into a word processor, text editor or any other program where the interpretation of key presses is generally undertaken by software. A computer keyboard distinguishes each physical key from every other key and reports all key presses to the controlling software. A keyboard comprises solely a touchscreen or touch pad element, solely a physical keyboard with buttons or keys or a composite keyboard comprising both a touchscreen or touchpad portion and a physical keyboard portion.

A “computer mouse” (mouse) as used herein, and throughout this disclosure, refers to a is a hand-held pointing device that detects two-dimensional motion or three-dimensional motion. This motion is typically translated into the motion of a pointer on a display, which allows a smooth control of the graphical user interface of a computer.

A “graphical user interface” (GUI) as used herein, and throughout this disclosure, refers to form of user interface that allows users to interact with an electronic device through graphical elements, graphical objects and graphical icons rendered to the user instead of text-based user interfaces, typed command labels or text navigation. The actions in a GUI are usually performed through direct “manipulation” of the graphical elements rendered. Beyond computers, GUIs are used in many PEDs and FEDs including, but not limited, to handheld mobile devices such as MP3 players, portable media players, gaming devices, smartphones, etc. as well as smaller household, office and industrial controls together with kiosks and terminals.

A “head-mounted display” (HMD) system (also known as a near-to-eye (NR2I) HMD, virtual reality (VR) headset, etc.) as employed herein and throughout this disclosure refers to a wearable device that incorporates a display or displays for rendering content operating in conjunction with a microprocessor such that a predetermined portion of an image is rendered (presented) to the user wearing the HMD on the image presentation device. An HMD may be configured immersive, wherein the user views the display absent any direct external visual view, or non-immersive, wherein the user views the display in conjunction with their direct external visual view. Configurations of HMD and their associated display(s) may include immersive with direct viewer viewing of display, immersive with indirect viewer viewing of display through an intermediate optical assembly, non-immersive with direct viewer viewing of display, which is substantially transparent, and immersive with indirect viewer viewing of display through an intermediate optical assembly. Non-immersive configurations may employ a non-transparent display and/or optical assembly or semi-transparent display and/or optical assembly where the display presents to a smaller field of view than the user's full field of view or is within their outer field of view or peripheral vision such that it does not overlay the central portion of their field of view. An HMD may be monocular or binocular. An HMD may be fixed, i.e. when worn it is in a fixed configuration relative to the user's head, or bioptic, i.e. when worn it allows the user to vary the configuration relative to their head so that the display is in two (2), three (3), or more predetermined positions and/or may be continuously or pseudo-continuously variable.

It is common to use a pointing device such as a mouse, touchpad, trackball, joystick, etc., in conjunction with a microprocessor based system rendering content to a user to click on objects on a computer screen and/or graphical user interface (“GUI”) and for software in execution upon the microprocessor based system to interpret the actions and act upon them, one object at a time. By their nature, these pointing devices only allow clicking on a single GUI object at a time.

Accordingly, prior art GUI interfaces with pointing devices requires moving a pointer rendered on the screen across the screen to point overlapping an object on the screen, and the pushing of a button to act upon this object. Such an interface is by its inherent nature serial as user actions must be performed in series. In many instances, a first GUI element may trigger a new screen to be displayed overlaying a second GUI element the user wishes to access necessitating additional GUI related actions to access the second GUI element.

In other circumstances the use of a pointing device is not feasible, e.g. with a laptop sitting on public transport, when the battery in the pointing device is drained, etc. Whilst touchscreens are available for laptops these tend to be more expensive limiting their deployment but they still require the manipulation of the pointer and actions in common with the same process as if the user were using a discrete pointing device, it is now their finger upon the touchscreen.

Accordingly, embodiments of the invention address these limitations within the prior art by providing users with a keyboard driven GUI interface allowing the user to perform actions normally reserved for pointing device driven GUI interfaces. Embodiments of the invention further provide for keyboard driven GUI interfaces which support multiple concurrent actions by the user which may be associated with a single piece of software, e.g. an operating system such as Microsoft™ Windows or Apple™ macOS for example, or multiple pieces of software, e.g. software applications. Accordingly, embodiments of the invention support GUI interfaces absent touchscreens, pointers, etc. either because they are absent, their use impractical or they have failed.

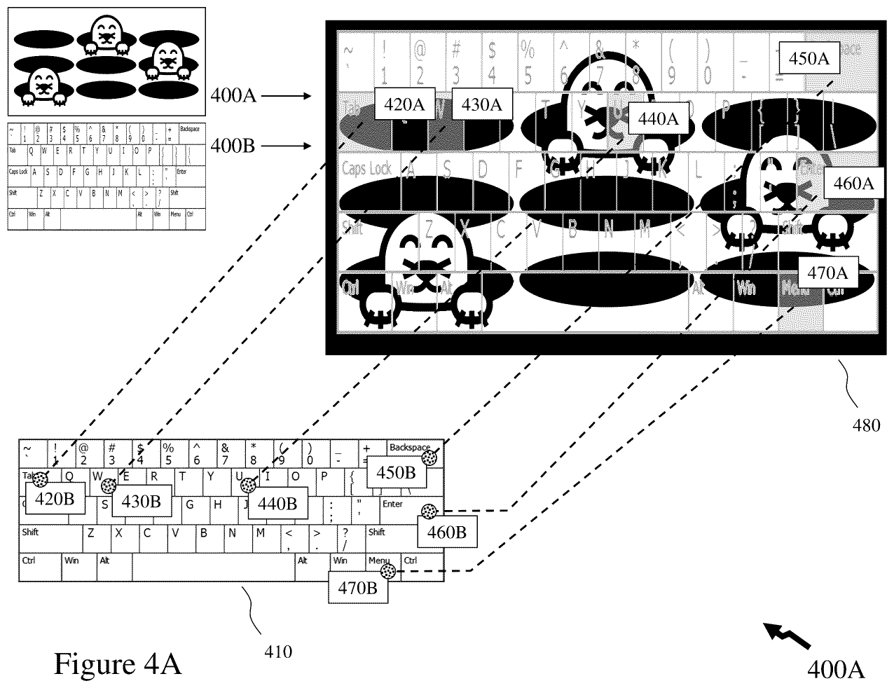

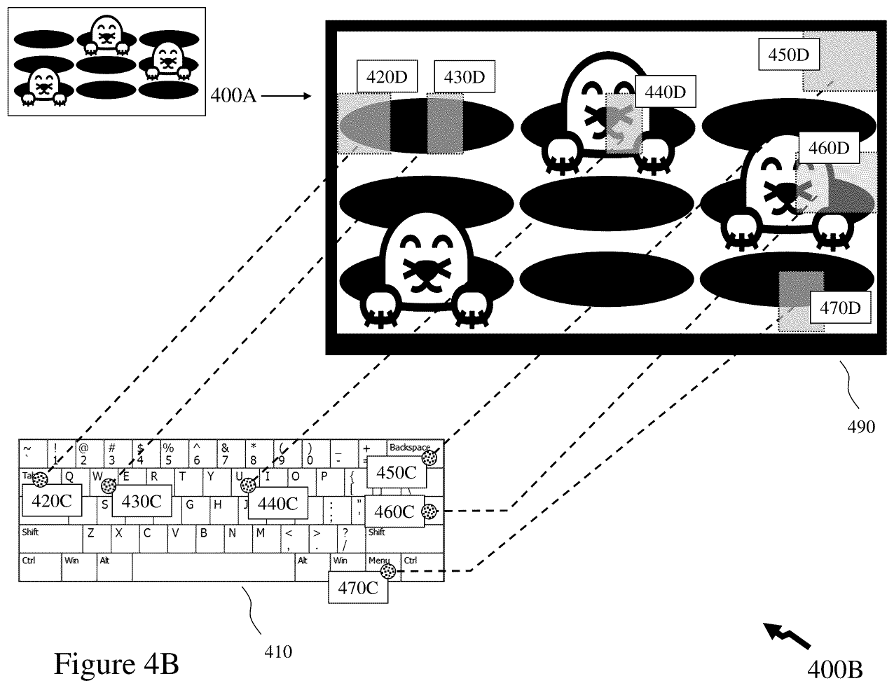

Embodiments of the invention employ a keyboard, normally employed for entering character based content, as an input pointing device for selecting GUI elements and performing actions with them. As will become evident with respect to embodiments of the invention described and depicted with respect to FIGS. 4 to 16 the keyboard, or a subset of the keyboard, can be mapped to a full screen, a subset of a screen, multiple screens, etc. If it is mapped to a subset of a screen then the subset may be statically defined or it may be dynamically defined such as automatically based upon a context of the GUI elements, system, etc. or manually defined by the user. Within other embodiments of the invention software in execution upon the device may map the GUI elements to a softboard established in dependence upon the keyboard. Within other embodiments of the invention multiple keyboards may be employed to map to a single screen or to multiple screens.

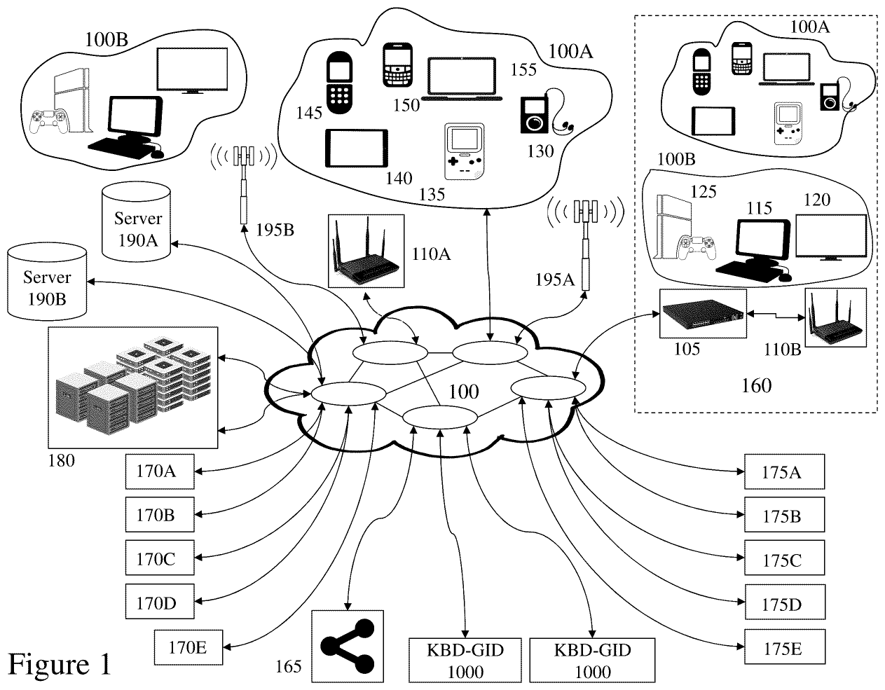

Referring to FIG. 1 there is depicted a Network 100 within which embodiments of the invention may be employed supporting Keyboard (KBD) Graphical User Interface (KBDGUI) Systems, Applications and Platforms (KBDGUI-SAPs) according to embodiments of the invention. Such KBDGUI-SAPs, for example, supporting multiple communication channels, dynamic filtering, etc. As shown first and second User Groups 100A and 100B respectively interface to a telecommunications Network 100. Within the representative telecommunication architecture, a remote central exchange 180 communicates with the remainder of a telecommunication service providers network via the Network 100 which may include for example long-haul OC-48/OC-192 backbone elements, an OC-48 wide area network (WAN), a Passive Optical Network, and a Wireless Link. The central exchange 180 is connected via the Network 100 to local, regional, and international exchanges (not shown for clarity) and therein through Network 100 to first and second cellular APs 195A and 195B respectively which provide Wi-Fi cells for first and second User Groups 100A and 100B respectively. Also connected to the Network 100 are first and second Wi-Fi nodes 110A and 110B, the latter of which being coupled to Network 100 via router 105. Second Wi-Fi node 110B is associated with commercial service provider 160, e.g. Gillette Stadium™, comprising other first and second User Groups 100A and 100B. Second User Group 100B may also be connected to the Network 100 via wired interfaces including, but not limited to, DSL, Dial-Up, DOCSIS, Ethernet, G.hn, ISDN, MoCA, PON, and Power line communication (PLC) which may or may not be routed through a router such as router 105.

Within the cell associated with first Access Point 110A the first group of users 100A may employ a variety of PEDs including for example, laptop computer 155, portable gaming console 135, tablet computer 140, smartphone 150, cellular telephone 145 as well as portable multimedia player 130. Within the cell associated with second Access Point 110B are the second group of users 100B which may employ a variety of FEDs including for example gaming console 125, personal computer 115 and wireless/Internet enabled television 120 as well as cable modem 105. First and second cellular APs 195A and 195B respectively provide, for example, cellular GSM (Global System for Mobile Communications) telephony services as well as 3G and 4G evolved services with enhanced data transport support. Second cellular Access Point 195B provides coverage in the exemplary embodiment to first and second User Groups 100A and 100B. Alternatively the first and second User Groups 100A and 100B may be geographically disparate and access the Network 100 through multiple access points, not shown for clarity, distributed geographically by the network operator or operators. First cellular Access Point 195A as show provides coverage to first User Group 100A and environment 170, which comprises second User Group 100B as well as first User Group 100A. Accordingly, the first and second User Groups 100A and 100B may according to their particular communications interfaces communicate to the Network 100 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first User Group 100A may form associations either through standards, such as IEEE 802.15 and Bluetooth for example, as well in an ad-hoc manner.

Also connected to the Network 100 are Social Networks (SOCNETS) 165, first and second Service Providers 170A and 170B respectively, first and second third party Service Providers 170C and 170D respectively, and a User 170E. Also connected to the Network 100 are first and second Enterprises 175A and 175B respectively, first and second Organizations 175C and 175D respectively, and a Government Entity 175E. Also depicted are first and second servers 190A and 190B may host according to embodiments of the inventions multiple services associated with a provider of contact management systems and contact management applications/platforms (KBDGUI-SAPs); a provider of a SOCNET or Social Media (SOME) exploiting KBDGUI-SAP features; a provider of a SOCNET and/or SOME not exploiting KBDGUI-SAP features; a provider of services to PEDS and/or FEDS; a provider of one or more aspects of wired and/or wireless communications; an Enterprise 160 such as Microsoft™ exploiting KBDGUI-SAP features; license databases; content databases; image databases; content libraries; customer databases; websites; and software applications for download to or access by FEDs and/or PEDs exploiting and/or hosting KBDGUI-SAP features. First and second primary content servers 190A and 190B may also host for example other Internet services such as a search engine, financial services, third party applications and other Internet based services.

Also depicted in FIG. 1 are Keyboard GUI Interfaced Devices (KBD-GIDs) 1000 according to embodiments of the invention such as described and depicted below in respect of FIGS. 4A to 16. As depicted in FIG. 1 the KBD-GIDs 1000 communicate directly to the Network 100. The KBD-GIDs 1000 may communicate to the Network 100 through one or more wireless or wired interfaces included those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, a user may exploit a PED and/or FED within an Enterprise 160, for example, and access one of the first or second primary content servers 190A and 190B respectively to perform an operation such as accessing/downloading an application which provides KBDGUI-SAP features according to embodiments of the invention; execute an application already installed providing KBDGUI-SAP features; execute a web based application providing KBDGUI-SAP features; or access content. Similarly, a user may undertake such actions or others exploiting embodiments of the invention exploiting a PED or FED within first and second User Groups 100A and 100B respectively via one of first and second cellular Access Points 195A and 195B respectively and first Wi-Fi nodes 110A. It would also be evident that a user may, via exploiting Network 100 communicate via telephone, fax, email, SMS, social media, etc.

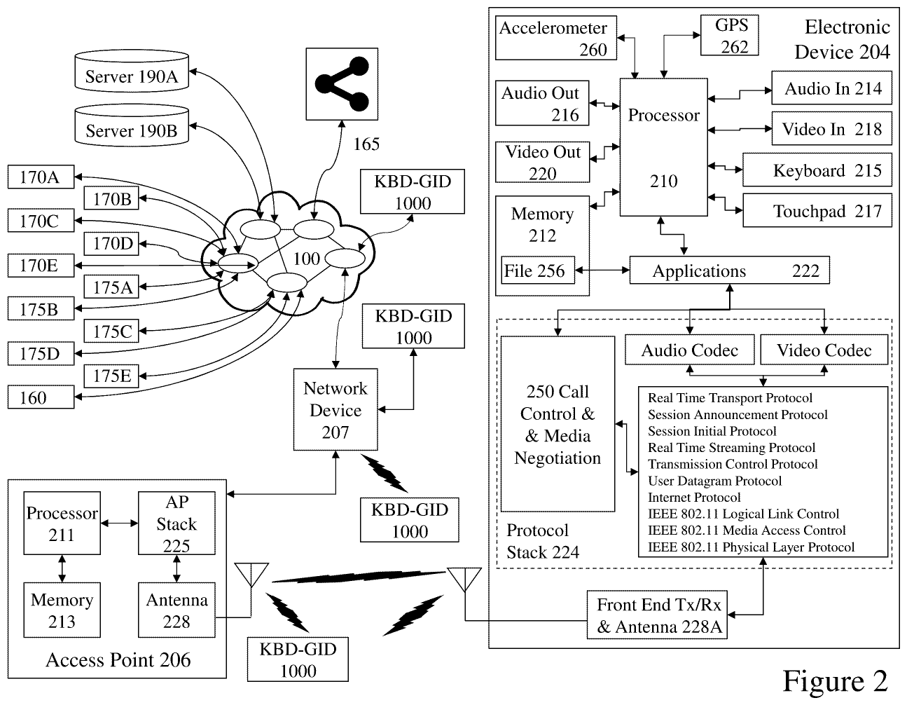

Now referring to FIG. 2 there is depicted an Electronic Device 204 and network access point 207 supporting KBDGUI-SAP features according to embodiments of the invention. Accordingly, Electronic Device 204 may embody an embodiment of a KBD-GID 1000 as depicted in FIGS. 1 and 2 respectively. Electronic Device 204 may, for example, be a PED and/or FED and may include additional elements above and beyond those described and depicted. Also depicted within the Electronic Device 204 is the protocol architecture as part of a simplified functional diagram of a system 200 that includes an Electronic Device 204, such as a smartphone 155, an Access Point 206, such as first Access Point 110 in FIG. 1 for example, and one or more Network Devices 207, such as communication servers, streaming media servers, and routers for example such as first and second servers 190A and 190B respectively. Network Devices 207 may be coupled to Access Point 206 via any combination of networks, KBD-GID 1000, and wireless and/or optical communication links such as discussed above in respect of FIG. 1 as well as directly as indicated. Network devices 207 are coupled to Network 100 and therein Social Networks (SOCNETS) 165, first and second Service Providers 170A and 170B respectively, first and second third party Service Providers 170C and 170D respectively, a User 170E, first and second Enterprises 175A and 175B respectively, first and second Organizations 175C and 175D respectively, and a Government Entity 175E. As depicted Electronic Device 204 is coupled to Access Point 206 directly and indirectly via KBD-GIDs 10000 which may form part of an unstructured or ad-hoc network incorporating the Access Point 206 and Electronic Device 204. Optionally, one or more of the KBD-GIDs 10000 depicted as providing part of a routing between the Electronic Device 204 and Access Point 206 may be conventional PEDs and/or FEDs forming part of unstructured or ad-hoc network incorporating the Access Point 206 and Electronic Device 204

The Electronic Device 204 includes one or more Processors 210 and a Memory 212 coupled to Processor(s) 210. Access Point 206 also includes one or more Processors 211 and a Memory 213 coupled to processor(s) 210. A non-exhaustive list of examples for any of Processors 210 and 211 includes a central processing unit (CPU), a digital signal processor (DSP), a reduced instruction set computer (RISC), a complex instruction set computer (CISC) and the like. Furthermore, any of Processors 210 and 211 may be part of application specific integrated circuits (ASICs) or may be a part of application specific standard products (ASSPs). A non-exhaustive list of examples for Memories 212 and 213 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic Device 204 may include an audio input element 214, for example a microphone, and an Audio Output Element 216, for example, a speaker, coupled to any of Processors 210. Electronic Device 204 may include a Video Input Element 218, for example, a video camera or camera, and a Video Output Element 220, for example an LCD display, coupled to any of Processors 210. Electronic Device 204 also includes a Keyboard 215 and Touchpad 217 which may for example be a physical keyboard and touchpad allowing the user to enter content or select functions within one of more Applications 222 as well as access other applications through the Internet, etc. Alternatively, the Keyboard 215 and Touchpad 217 may be predetermined regions of a touch sensitive element forming part of the Electronic Device 204. The one or more Applications 222 that are typically stored in Memory 212 and are executable by any combination of Processors 210. Electronic Device 204 also includes Accelerometer 260 providing three-dimensional motion input to the Processor 210 and GPS 262 which provides geographical location information to Processor 210.

Electronic Device 204 includes a Protocol Stack 224 and AP 206 includes an AP Stack 225. Within Protocol Stack 224 is shown an IEEE 802.11 protocol stack but alternatively may exploit other protocol stacks such as an Internet Engineering Task Force (IETF) multimedia protocol stack for example or another protocol stack. Likewise, AP Stack 225 exploits a protocol stack but is not expanded for clarity. Elements of Protocol Stack 224 and AP Stack 225 may be implemented in any combination of software, firmware and/or hardware. Protocol Stack 224 includes a presentation layer Call Control and Media Negotiation module 250, one or more audio codecs and one or more video codecs. Applications 222 may be able to create maintain and/or terminate communication sessions with the Network Device 207 by way of AP 206 and therein via the Network 100 to one or more of Social Networks (SOCNETS) 165; first and second remote systems 170A and 170B respectively; first and second websites 175A and 175B respectively; first and third 3rd party service providers 175C and 175E respectively; and first and second servers 190A and 190B respectively. Embodiments of the invention as described below may be employed within standalone applications in execution upon Electronic Device 204 or they may applications in execution upon a virtual machine within a remote access session with a remote access system executed by and/or accessed by the Electronic Device 204 via the Network 102 on one or more of first and second websites 175A and 175B respectively; first and third 3rd party service providers 175C and 175E respectively; and first and second servers 190A and 190B respectively.

Typically, Applications 122 may activate the Call Control & Media Negotiation 150 module or other modules within the Protocol Stack 1241t would be apparent to one skilled in the art that elements of the Electronic Device 204 may also be implemented within the AP 106 including but not limited to one or more elements of the Protocol Stack 124 Portable electronic devices (PEDs) and fixed electronic devices (FEDs) represented by Electronic Device 204 may include one or more additional wireless or wired interfaces in addition to or in replacement of the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1010, DSL, Dial-Up, DOCSIS, Ethernet, G.hn, ISDN, MoCA, PON, and Power line communication (PLC).

Also depicted in FIG. 2 are Keyboard GUI Interfaced Devices (KBD-GIDs) 1000 according to embodiments of the invention such as described and depicted below in respect of FIGS. 4A to 16. As depicted in FIG. 2 a KBD-GID 1000 may communicate directly to the Network 100. Other KBD-GIDs 1000 may communicate to the Network Device 207, Access Point 206, and Electronic Device 204. Some KBD-GIDs 1000 may communicate to other KBD-GIDs 1000 directly. Within FIG. 2 the KBD-GIDs 1000 coupled to the Network 100 and Network Device 207 communicate via wired interfaces. The KBD-GIDs 1000 coupled to the Access Point 206 and Electronic Device 204 communicate via wireless interfaces. Each KBD-GID 100 may communicate to another electronic device, e.g. Access Point 206, Electronic Device 204 and Network Device 207, or a network, e.g. Network 100. Each KBD-GID 100 may support one or more wireless or wired interfaces including those, for example, selected from the group comprising IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 2 depicts an Electronic Device 204, e.g. a PED, wherein one or more parties including, but not limited to, a user, users, an enterprise, enterprises, third party provider, third party providers, wares provider, wares providers, financial registry, financial registries, financial provider, and financial providers may engage in one or more financial transactions relating to an activity including, but not limited to, e-business, P2P, C2B, B2B, C2C, B2G, C2G, P2D, and D2D via the Network 100 using the electronic device or within either the access point 206 or Network Device 207 wherein details of the transaction are then coupled to the Network 100 and stored within remote servers.

Optionally, rather than wired and./or wireless communication interfaces devices may exploit other communication interfaces such as optical communication interfaces and/or satellite communications interfaces. Optical communications interfaces may support Ethernet, Gigabit Ethernet, SONET, Synchronous Digital Hierarchy (SDH), etc.

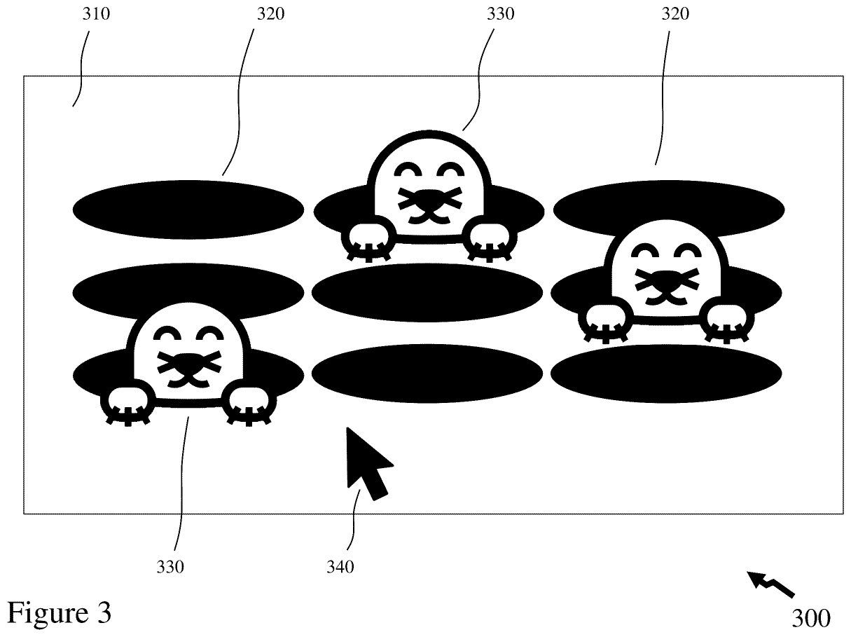

Referring to FIG. 3 there is depicted an exemplary screen 300 of a game requiring a user to perform actions to progress within the game as may be employed within the prior art with a touch screen or mouse as an input interface for the user. As depicted the screen 300 displays within a GUI 310 a series of “holes” 320 where randomly under control of the application providing the game a character 330 appears for a period of time and disappears. The aim of the game being to “hit” the character 330 when they appear to score points. Accordingly, the user is expected to move a pointer 340 with a pointing device, e.g. mouse, till it overlaps a character and “click” or “double-click” to “hit” the character 330. Hence, absent a pointing device the user cannot move the pointer 340 unless the game generating the GUI 310 provides specific keys for the user to move the pointer 340, e.g. arrow buttons if physically implemented on their keyboard or letters such as Z, X, C, V, “space bar” for up, down, left, right and hit respectively.

Referring to FIG. 4A there is depicted an exemplary mapping of a screen displayed to a user to a keyboard allowing the user to employ the keyboard as an input interface according to an embodiment of the invention. Accordingly, a GUI 480 rendered to a user is displayed together with a keyboard 410 the user is employing on the system to which the display rendering the GUI 480 relates. GUI 480 comprising a first layer 400A depicting the output of the game, such as that depicted in GUI 310 in FIG. 3, and a soft keyboard (softboard) 400B (e.g. an image of the keyboard 410). Accordingly, an application in execution upon the device to which the keyboard 410 and GUI 480 are both associated associates a user's physical action with the keyboard 410 as being the process of moving a pointer and “clicking” or “double-clicking” to trigger an action with respect to the GUI 480. Accordingly, a single keystroke upon the keyboard now replaces two physical actions of the user with a pointing device.

It would therefore be evident that the application in execution upon the device associates a softboard defining the softboard 400B representing the physical layout of the keyboard 410 with the game so that user keystrokes on the physical keyboard 410 are associated with predetermined regions of the GUI 480. The application in execution upon the device may be the operating system (OS) of the device, an application associated with the GUI 480 or the game rendering the GUI 480, etc.

As depicted in FIG. 4A the softboard 400B defines which regions of the first layer 400A are associated with which keys on the keyboard 410. Accordingly, as depicted:
First key stroke 420B upon the “TAB” key results in a user action within the first region 420A of the GUI 480;
Second key stroke 430B upon the “W” key results in a user action within the second region 430A of the GUI 480;
Third keystroke 440B upon the “U” key results in a user action within the third region 440A of the GUI 480;
Fourth keystroke 450B upon the “BACKSPACE” key results in a user action within the fourth region 450A of the GUI 480;
Fifth keystroke 460B upon the “ENTER” key results in a user action within the fifth region 460A of the GUI 480; and
Sixth keystroke 470B upon the “MENU” key results in a user action within the sixth region 470A of the GUI 480.

Referring to FIG. 4B there is depicted an exemplary mapping of a screen displayed to a user to a keyboard allowing the user to employ the keyboard as an input interface according to an embodiment of the invention. Accordingly, a GUI 490 rendered to a user is displayed together with a keyboard 410 the user is employing on the system to which the display rendering the GUI 490 relates. GUI 490 comprising a first layer 400A depicting the output of the game, such as that depicted in GUI 310 in FIG. 3, but absent a softboard such as described and depicted in respect of FIG. 4A (e.g. an image of the keyboard 410). Accordingly, an application in execution upon the device to which the keyboard 410 and GUI 490 are both associated associates a user's physical action with the keyboard 410 as being the process of moving a pointer and “clicking” or “double-clicking” to trigger an action with respect to the GUI 490. Accordingly, a single keystroke upon the keyboard now replaces two physical actions of the user with a pointing device.

Within the system as depicted in FIG. 4B the softboard 400B defines which regions of the first layer 400A are associated with which keys on the keyboard 410. Accordingly, as depicted:
First key stroke 420C upon the “TAB” key results in a user action within the first region 420D of the GUI 490;
Second key stroke 430C upon the “W” key results in a user action within the second region 430D of the GUI 490;
Third keystroke 440C upon the “U” key results in a user action within the third region 440D of the GUI 490;
Fourth keystroke 450C upon the “BACKSPACE” key results in a user action within the fourth region 450D of the GUI 490;
Fifth keystroke 460C upon the “ENTER” key results in a user action within the fifth region 460D of the GUI 490; and
Sixth keystroke 470C upon the “MENU” key results in a user action within the sixth region 470D of the GUI 490.

Accordingly, in contrast to GUI 480 in FIG. 4A the GUI 490 does not render the “softboard” overlay, softboard 400B, to the user in conjunction with the first layer 400A. This may be based upon a user preference, for example, or alternatively it may a setting of the operating system, application, etc. or a difficulty level of a game such that in “easy” levels the softboard is depicted but is not in “hard” levels so that the user is required to remember what keys of the keyboard 410 are associated with what regions of the GUI 490 and therein the first layer 400A.

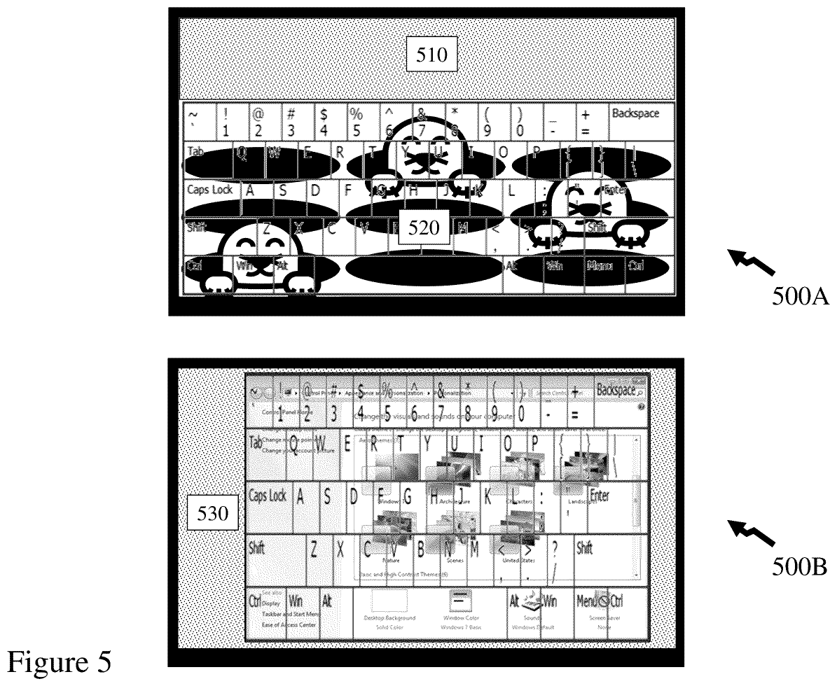

Now referring to FIG. 5 there is depicted exemplary first and second mappings 500A and 500B of a screen displayed to a user to a keyboard allowing the user to employ the keyboard as an input interface according to an embodiment of the invention. Accordingly, referring to first mapping 500A the rendered GUI presented to the user comprises a first region 510 and a second region 520 wherein the softboard is only rendered in the second region 520. Accordingly, user actions with respect to the physical keyboard (not depicted for clarity) to which the softboard refers are only effective in respect of their associated mapped sub-regions within the second region 520. Similarly, referring to second mapping 500B the rendered GUI presented to the user comprises a third region 530 and a fourth region 540 wherein the softboard is only rendered in the fourth region 540. Accordingly, user actions with respect to the physical keyboard (not depicted for clarity) to which the softboard refers are only effective in respect of their associated mapped sub-regions within the fourth region 540. It would be evident that within each of the first and second mappings 500A and 500B the regions, second region 520 and fourth region 540 respectively, may be defined by an application exploiting the softboards and/or by an application controlling the rendering of the second region 520 and fourth region 540 respectively. Accordingly, in each instance a user and/or a first application may resize the respective second region 520 and fourth region 540 so that the portion of the overall GUI associated with the softboard varies. A user may, for example, resize a window within the overall GUI associated with the application exploiting the softboard. Alternatively, a software application may automatically resize and/or move the window within the overall GUI associated with the application exploiting the softboard upon either another user action, e.g. opening another application, or upon the application determining that resizing and/or moving the window is appropriate. For example, a first application (e.g. browser or operating system) may seek to avoid having a window overlapped by another when the user opens another window and/or a second application.

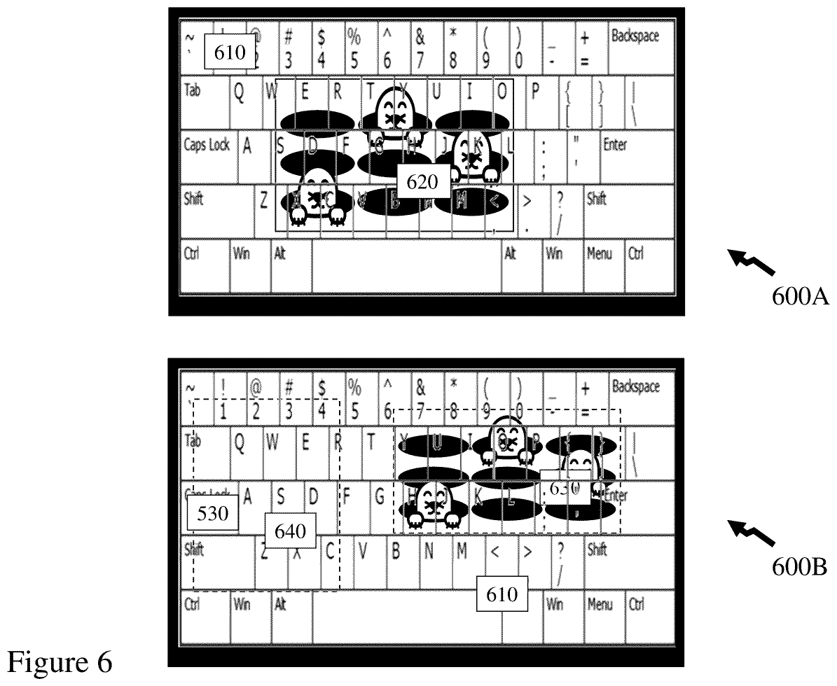

Referring to FIG. 6 there is depicted exemplary first and second mappings 600A and 600B of a screen displayed to a user to a keyboard allowing the user to employ the keyboard as an input interface according to an embodiment of the invention. Accordingly, referring to first mapping 600A the rendered GUI presented to the user comprises a softboard 610 and an application window 620 wherein the softboard 610 defined by a softboard is rendered independent of the application window 620. Accordingly, user actions with respect to the physical keyboard (not depicted for clarity) to which the softboard refers are effective in respect of their associated mapped sub-regions within the rendered GUI overall. Accordingly, as depicted user actions with respect to the keys W, E, R, T, Y, U, I, O, S, D, F, G, H, J, K, L, Z, X, C, V, B, N, and M, comma (,), will result in an action with respect to the associated portion of the application window 620.

Similarly, referring to second mapping 600B the rendered GUI presented to the user comprises the softboard 610 which is rendered independent of a pair of application windows, first application window 630 and second application window 640. Accordingly, user actions with respect to the physical keyboard (not depicted for clarity) to which the softboard refers are effective in respect of their associated mapped sub-regions within the rendered GUI overall. In this manner user actions with respect to backtick (\grave{ }), 1, 2, 3, TAB, Q, W, E, R, CAPS LOCK, A, S, D, left SHIFT, Z, X, and C will result in an action with respect to the associated portion of the second application window 640 whilst user actions with respect to 6, 7, 8, 9, 0.-.=, BACKSPACE, Y, U, I, O, P, [,], H, J, K, L, semi-colon (;), apostrophe ('), and ENTER will result in an action with respect to the associated portion of the first application 630. It would be evident that in other embodiments of the invention it is only those keys associated with an active application window or selected application window may be undertaken. Accordingly, if the user opened or selected first application window 630 then only user actions with respect to keys 6, 7, 8, 9, 0.-.=, BACKSPACE, Y, U, I, O, P, [,], H, J, K, L, semi-colon (;), apostrophe ('), and ENTER will result in an action with respect to the associated portion of the first application 630 and user actions with respect to any other keys would not trigger any action. Similarly, if the user opened or selected second application window 640 then only user actions with respect to backtick (\grave{ }), 1, 2, 3, TAB, Q, W, E, R, CAPS LOCK, A, S, D, left SHIFT, Z, X, and C will result in an action with respect to the associated portion of the second application window 640 and user actions with respect to any other keys would not trigger any action. Accordingly, it would be evident that triggering an action with respect to a window rendered within the GUI to the user may be context driven. Hence, if the application window was a word processor, for example, then the user's keystrokes with respect to the keyboard would be interpreted as text entry whereas if it was a game they are interpreted as gaming actions. Another way to decide on the context is via user input; e.g. when the user presses the ESC key, it toggles between keystrokes mode and pointing mode.

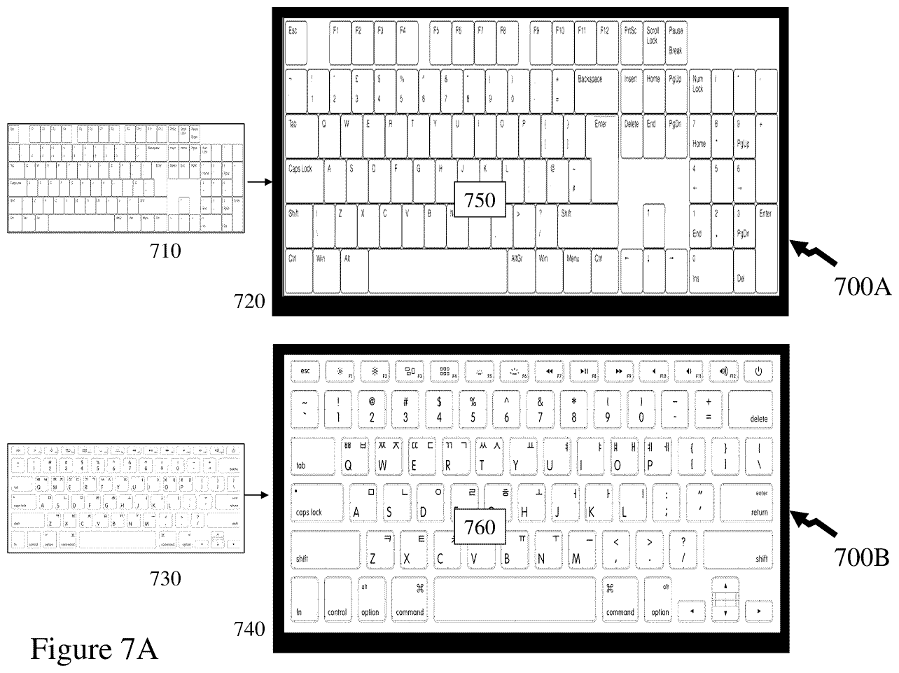

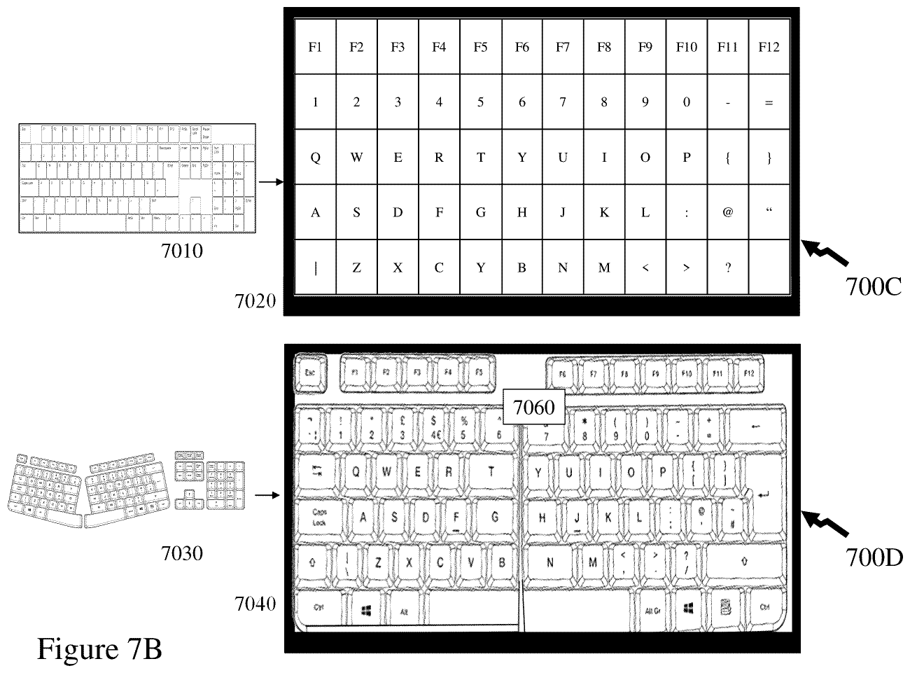

Now referring to FIG. 7A there are depicted exemplary first and second mappings 700A and 700B of physical keyboards to a softboard to define regions of a GUI associated with the actions to be performed by the user through actions upon the physical keyboard. Within first mapping 700A a first keyboard 710 attached to the device rendering the first GUI 720 results in first softboard 750 being mapped to the first GUI 720. Within second mapping 700B a second keyboard 730 (with different keys) attached to the device rendering the second GUI 740 results in second softboard 760 being mapped to the second GUI 740. Accordingly, within embodiments of the invention an application exploiting softboards may establish an identity of a physical keyboard associated with the device rendering a GUI associated with the application and accordingly establishes the appropriate softboard to employ either without rendering a representation of the softboard within the GIU such as depicted in FIG. 4B for example or with rendering the representation of the softboard within the GUI such as depicted in FIG. 4A for example. If the appropriate softboard is not stored within a memory accessible to the microprocessor of the device then the device may access one or more external repositories to identify and access the appropriate softboard, such as stored upon first and second servers 190A and 190B in FIGS. 1 and 2 respectively.

FIG. 7B depicts exemplary third and fourth mappings 700C and 700D of physical keyboards to a softboard via a softboard to define regions of a GUI associated with the actions to be performed by the user through actions upon the physical keyboard. Within third mapping 700C a third keyboard 7010 attached to the device rendering the third GUI 7020 results in third softboard 7050 being mapped to the third GUI 7020. Accordingly, only a portion of the third keyboard 7010 mapped to the third softboard 7050 but the third softboard 7050 has regions associated with each key which are determined by the dimensions of the grid of keys mapped such that each region is of a constant size independent of the exact spatial position of any associated physical key.

Within fourth mapping 700D a fourth keyboard 7030 attached to the device rendering the fourth GUI 7040 results in fourth softboard 7060 being mapped to the fourth GUI 7040. Accordingly, not only is only a portion of the fourth keyboard 7030 mapped to the fourth softboard 7050 but the fourth softboard 7050 has a layout such that the regions of the screen are not directly mapped in spatial relationship to the keys upon the fourth keyboard 7030, but only the relative placement of neighbouring keys.

Optionally, within other embodiments of the invention some physical keys, e.g. the SPACEBAR may have multiple elements detecting the key's operation. If these are identified separately within software then within these other embodiments a single key may be mapped to multiple regions and operation of the “left side of the SPACEBAR” for example may trigger an action within a different region of the GUI to an operation of the “right side of the SPACEBAR.” A user might specify which part of the SPACEBAR zone they want to press e.g. using key combinations (LEFT ARROW+SPACEBAR, or SPACEBAR followed by TAB, or pressing SPACEBAR multiple times, etc.) or in combination with other input methods (mouse scroll button).

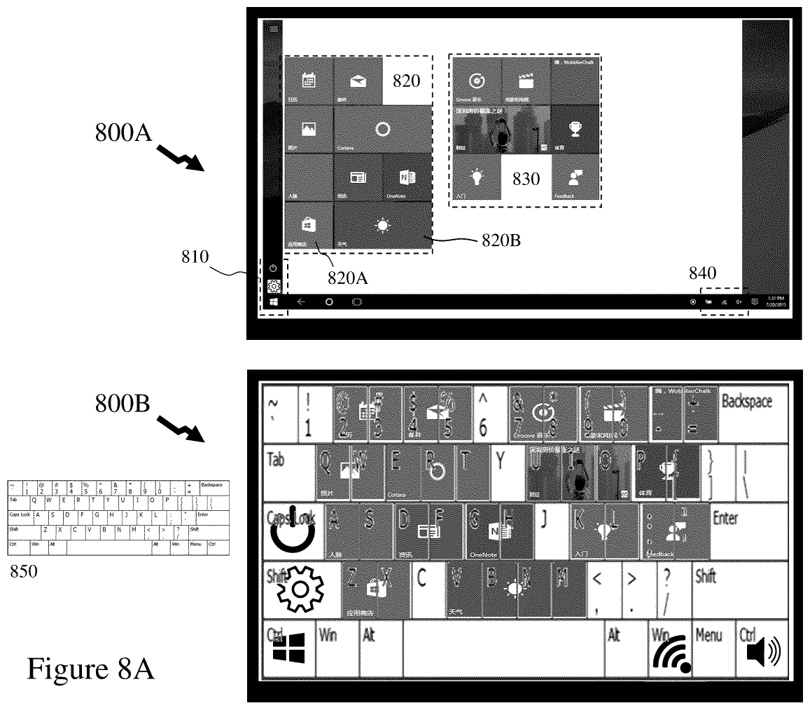

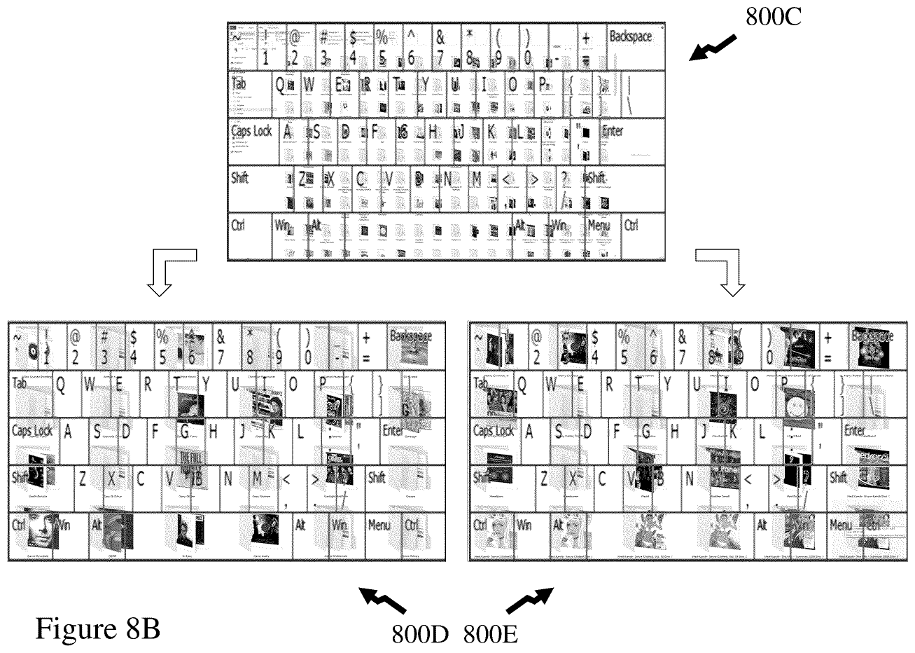

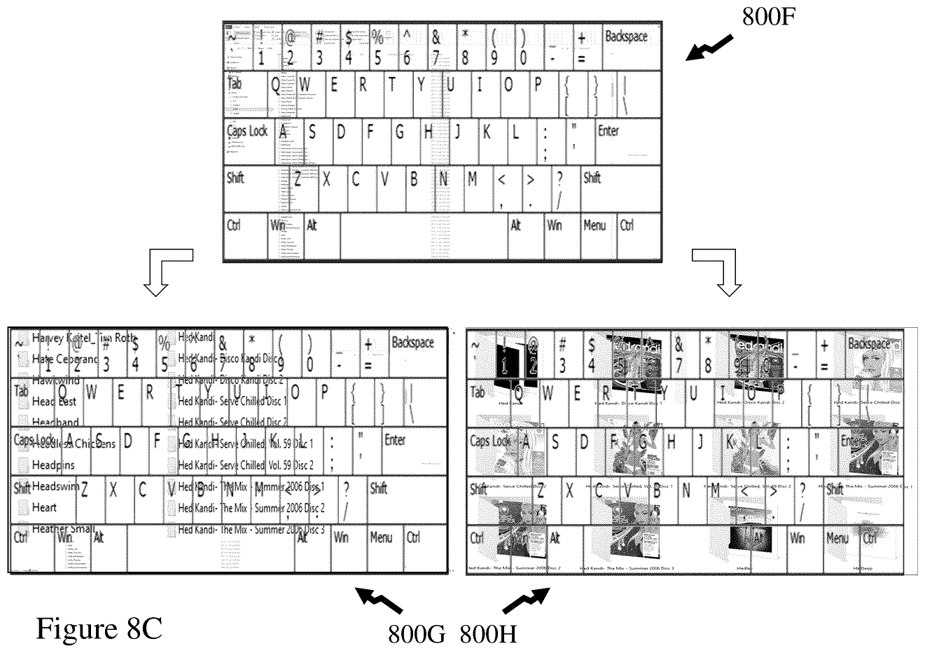

Referring to FIG. 8A there is depicted exemplary mapping of a screen displayed to a user allowing the user to employ a keyboard as an input interface according to an embodiment of the invention wherein the displayed image on the screen is modified in dependence upon a softboard associated with the keyboard in use. Within first GUI 800A the GUI is rendered to a user comprising elements within first to fourth regions 810 to 840 respectively. In this example:
the first region 810 is associated with system commands such as power, settings, and start menu;
the second region 820 is associated with a first set of application icons;
the third region 830 is associated with a second set of application icons; and
the fourth region 840 is associated with other system settings/indicators such as battery status, wireless settings, sound, etc.

Accordingly, in second GUI 800B a softboard overlay of a keyboard 850 is depicted together with an underlaying image which has been generated by the software so that the elements within the first to fourth regions 810 to 840 having actions associated with them are re-mapped so that they are defined within the softboard image of a single key or multiple keys. Accordingly, considering the first region 810 then the start menu has been mapped to the CTRL key, the settings icon to the SHIFT key, and the power icon to the CAPS LOCK KEY. Within the fourth region 840 the wireless element has been mapped to the WIN key and the sound ON/OFF icon to the CTRL key. The battery status icon as it has no function is not mapped. It would also be evident that each icon within second and third regions 820 and 840 respectively has been mapped to the softboard rendered on the GUI where the relative dimensions of the different icons within the first GUI 800A are reflected in their sizes within the second GUI 800B. Accordingly, first icon 820A in first GUI 800A is mapped to the Z and X keys within second GUI 800B and the second icon 820B in first GUI 800A is mapped to the V, B, N and M keys within second GUI 800B.

Within other embodiments of the invention an icon within the first GUI 800A may be mapped to a single key within the second GUI 800B independent of its dimensions within the first GUI 800A. Alternatively, within other embodiments of the invention an icon within the first GUI 800A may be mapped to a single key within the second GUI 800B where the key it is mapped to is dependent upon its dimensions within the first GUI 800A. Accordingly, referring to FIG. 8 the first icon 820A may be mapped to the Z key in the second GUI 800B whilst the second icon 820B is mapped to the SHIFT key. Accordingly, a software application in execution may maintain a mapping of icons/GUI elements to the softboard which is updated in dependence upon user actions, system actions, etc. For example, the addition of a new icon to first GUI 800A results in a mapping to keys within the second GUI 800B. In some instances where a number of icons exceeds the number of keys a progressive selection process such as depicted in FIGS. 8B and 8C may be employed or the user is asked to select an icon within first GUI 800A which will now no longer be mapped, e.g. an application they use less frequently than others.

Now referring to FIGS. 8B and 8C there are depicted exemplary mapping of a screen displayed to a user allowing the user to employ a keyboard as an input interface according to an embodiment of the invention wherein the displayed image on the screen is modified in a progression to allow selection of an element or icon where the number of these exceeds keys to map to or multiple icons are associated with a single key at an initial level. Referring to FIG. 8B a user is accessing an index of content stored within a memory, local and/or remote, which is rendered as a series of icons with a softboard in first GUI 800C. If the user selects a key, for example the key 2 in the upper left, the first GUI 800C transitions to second GUI 800D whereas if the user selects another key, for example the WIN key in the bottom right, then the first GUI 800C transitions to the third GUI 800E. In each of the second and third GUIs 800D and 800E respectively a portion of the index is rendered to the user with the softboard. This being a portion of the index before (where it exists) and after (where it exists) the portion associated with the specific key. Accordingly, whilst within the first GUI 800C each key was associated with multiple elements of the index in each of the second and third GUIs 800D and 800E the index content is now such that the majority of items of content are associated uniquely with a subset of the keys within the softboard and thereby the keys of the associated physical keyboard. In the instance, such as the SPACEBAR in the middle where multiple items of the content are still associated then selection of this key may trigger a further magnification of the content such as described and depicted in FIG. 8C for example. It would be evident that the rendering of items of content in second and third GUIs 800D and 800E respectively may employ other aspects of embodiments of the invention such as described and depicted in respect of FIGS. 8A, 9-11 and 12B for example.

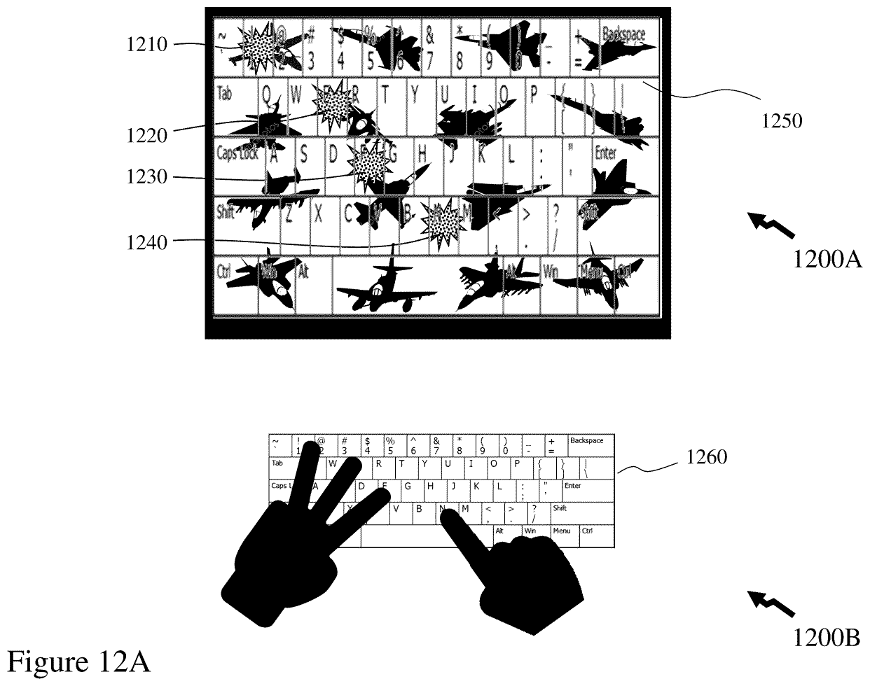

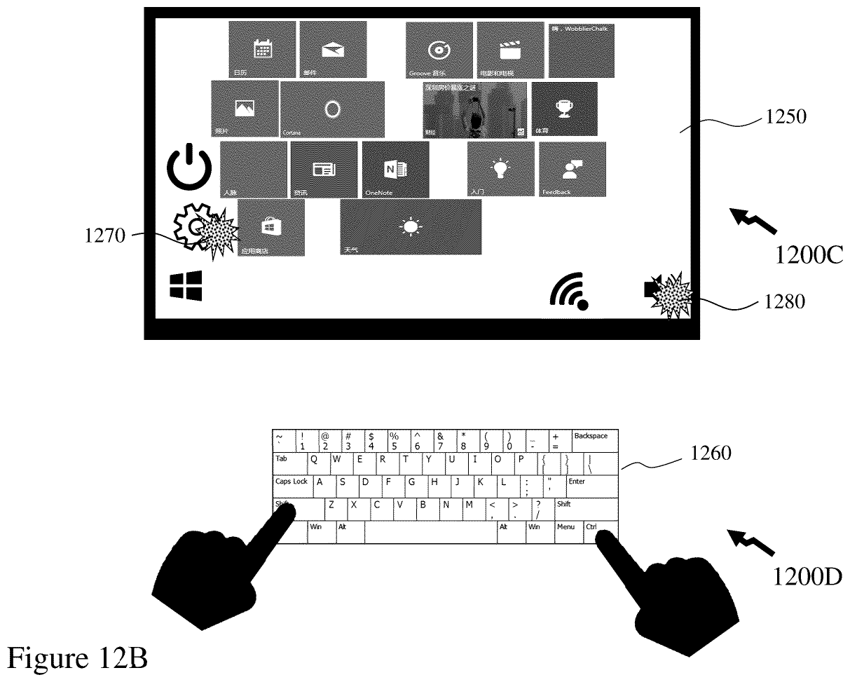

In FIG. 8C a user is accessing an index of content stored within a memory, local and/or remote, which is rendered as a list with a softboard in first GUI 800F. If the user selects a key, for example the key A then the first GUI 800F transitions to second GUI 800G wherein a part of the index before (where it exists) and after (where it exists) the portion associated with the specific key is rendered. Accordingly, each key is still associated with multiple items of content and accordingly if the user enters another key, for example the H key, then the second GUI 800G transitions to the third GUI 800H wherein a smaller portion of the index is now rendered. In third GUI 800H the application has also simultaneously changed the display format from a list to a series of icons. It may in other embodiments of the invention maintained the previous list format. In other embodiments of the invention the application may dynamically adjust the rendering style and the portion of index rendered, for example, in order to seek as rapidly as possible to ensure that each item of content is associated within one or more keys of the softboard allowing discrete user selection of that item. It would be evident that the rendering of items of content in second and third GUIs 800D and 800E respectively may employ other aspects of embodiments of the invention such as described and depicted in respect of FIGS. 8A, 9-11 and 12B for example. It would be further evident that other aspects of the invention such as described and depicted with respect to FIG. 12A may also be employed allowing the user to select multiple items or a range of items simultaneously. The near concurrent entry of two or more keys or other alternate key driven indication means such as double tapping each key may be employed to allow the user to define the multiple items and/or range of items to be selected and also indicate to the application that a further magnification of the content is not required as the user has now selected what they want. To go back to a lower level of magnification, the user may employ a key such as ESC, or using the mouse scroll wheel, or other methods. It may also happen automatically after a configurable period of inactivity by the user.

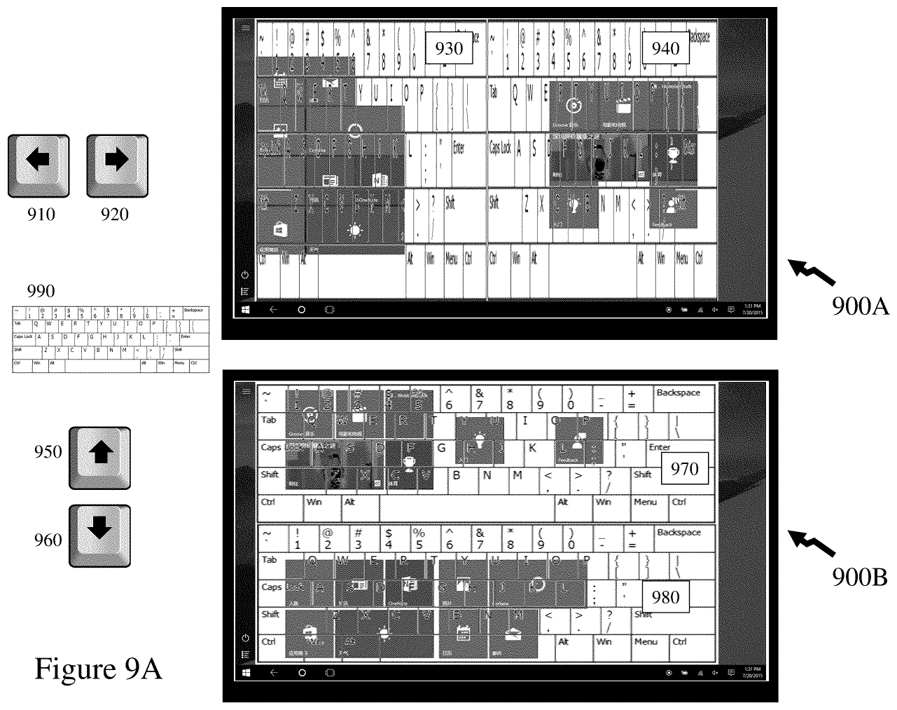

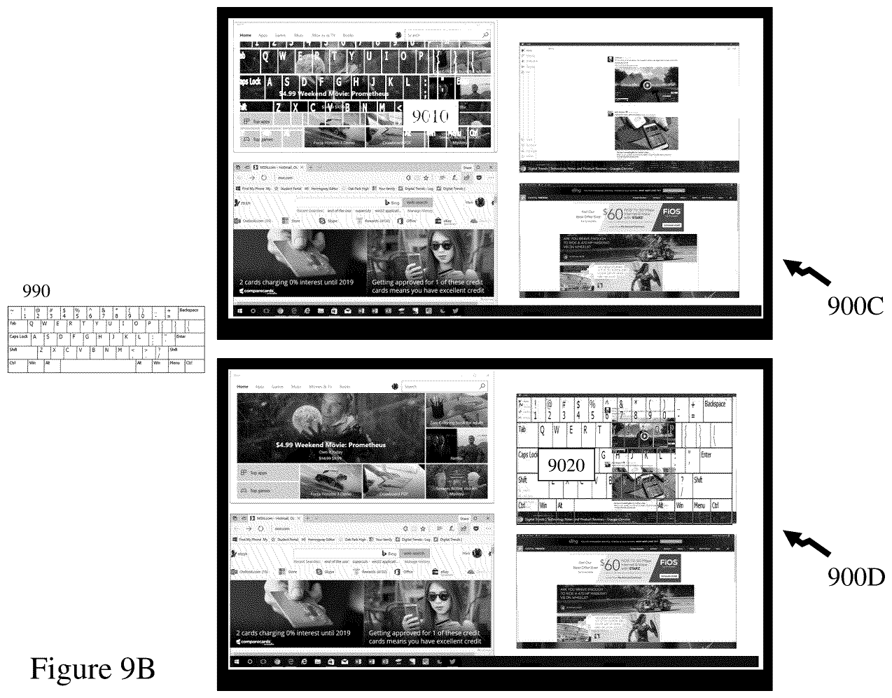

Referring to FIG. 9A there are depicted first and second images 900A and 900B respectively of exemplary mappings of portions of a screen displayed to a user to a keyboard allowing the user to employ the keyboard as an input interface according to an embodiment of the invention. First image 900A depicts first and second softboards 930 and 940 which are established in dependence upon a template 990 associated with a physical keyboard but are rendered in either the left or right portions of the screen/GUI based upon user selection of either a LEFT, LEFT ARROW or similar function key on the physical keyboard and a RIGHT, RGHT ARROW or similar function key on the physical keyboard. Accordingly, with a LEFT, LEFT ARROW or similar function key the template 990 is rendered as first softboard 930 whilst with a RIGHT, RGHT ARROW or similar function key the template 990 is rendered as second softboard 940. The portion of the screen being covered by the softboard can also be selected via other means such as the mouse, voice recognition, or other methods. It may also toggle automatically after a configurable amount of time of inactivity.

Within second image there are depicted third and fourth softboards 970 and 980 which are established in dependence upon a template 990 associated with a physical keyboard but are rendered in either the upper or lower portions of the screen/GUI based upon user selection of either an UP, UP ARROW or similar function key on the physical keyboard and a DOWN, DOWN ARROW or similar function key on the physical keyboard. Accordingly, with an UP, UP ARROW or similar function key the template 990 is rendered as third softboard 970 whilst with a DOWN, DOWN ARROW or similar function key the template 990 is rendered as fourth softboard 980. The portion of the screen being covered by the softboard can also be selected via other means such as the mouse, voice recognition, or other methods. It may also toggle automatically after a configurable amount of time of inactivity. Accordingly, a template 990 may be mapped to sub-regions of the screen based upon user entries upon the keyboard. Within another embodiment the selection of a pair of keys (e.g. a LEFT/RIGHT and an UP/DOWN) concurrently, simultaneously, or within a predetermined period of time may result, for example, in the upper left, upper right, lower left, or lower right portions of the screen/GUI. Other combinations and partial mappings would be evident to one skilled in the art. For example, pressing DOWN+RIGHT would put the softboard on the lower right portion of the screen.

This may be extended, as depicted in FIG. 9B for example, wherein third and fourth images 900C and 900D are depicted. Within third image 900C a fifth softboard 9010 is depicted overlaying a window displayed on the screen/GUI based upon a template 990 representing a physical keyboard. Accordingly, based upon the user selecting a different window, e.g. by use of the ALT+TAB key for example cycling through the active windows, the template 990 is rendered over each window in turn. Accordingly, as depicted in fourth image 900D the template 990 is now displayed as sixth softboard 9020 over a different window wherein the application controlling rendering of the softboards automatically dimensions the softboard to fit the application window. The window being covered by the softboard can also be selected via other means such as the mouse, voice recognition, or other methods. It may also toggle automatically after a configurable amount of time of inactivity.

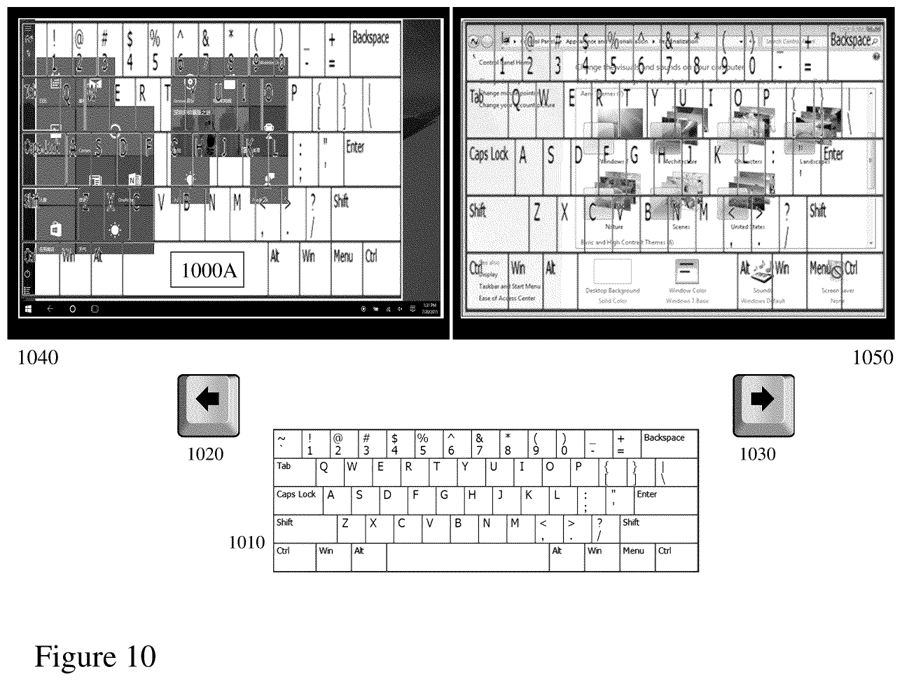

Referring to FIG. 10 there is depicted exemplary mapping of a pair of screens to a keyboard allowing the user to employ the keyboard as an input interface according to an embodiment of the invention. Accordingly, first and second physical screens 1040 and 1050 are depicted each displaying a different GUI to a user of the system comprising the first and second physical screens 1040 and 1050. Accordingly, an application in execution controlling the rendering of softboards renders a template 1010 upon the first physical screen 1040 as first softboard 1000A based upon the user selecting a LEFT, LEFT ARROW or similar function key on the physical keyboard or it renders the template 1010 upon the second physical screen 1050 as second softboard 1000B based upon the user selecting a RIGHT, RIGHT ARROW or similar function key on the physical keyboard. The physical screen being covered by the softboard can also be selected via other means such as the mouse, voice recognition, or other methods. It may also toggle automatically after a configurable amount of time of inactivity.

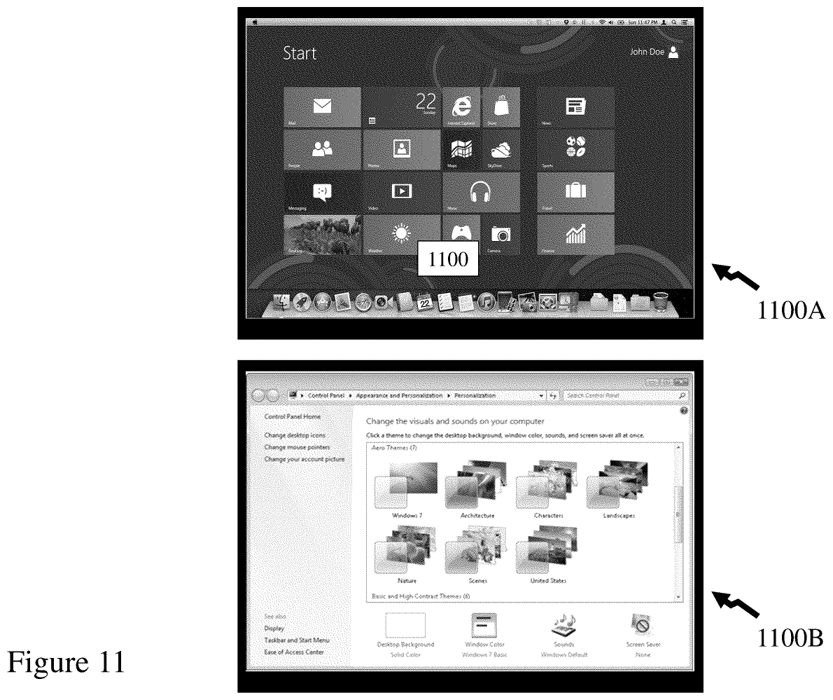

Referring to FIG. 11 there are depicted exemplary first and second images 1100A and 1100B of automatically colour mapped keyboard overlays onto a screen allowing the user to employ the keyboard as an input interface according to an embodiment of the invention. Accordingly, in first image 1100A a first softboard 1100 is depicted with “light” outlines to the softboard based upon the application in execution controlling the rendering of softboards determining that the screen/GUI upon which the softboard 1100 is overlaid is “dark.” In second image 1100B a second softboard 1150 is depicted with “dark” outlines to the softboard based upon the application in execution controlling the rendering of softboards determining that the screen/GUI upon which the softboard 1100 is overlaid is “light.” Accordingly, the template may be fixed but the colour/contrast of the resulting softboard adjusted to increase visibility to the user when the softboard is rendered. Optionally, within other embodiments of the invention the softboard may be multiple colours/contrasts rather than a single colour/contrast as depicted in first and second images 1100A and 1100B respectively. Within embodiments of the invention the colour, contrast, brightness and other aspects of rendering a softboard to the user may be automatically established by the application rendering the softboard based upon processing of the rendered GUI (e.g. using a XOR operation on the graphical image to ensure the highest contrast possible) either directly or via its being captured as a screenshot and graphical image processing being applied to the captured screenshot. The latter being beneficial in embodiments of the invention where the application being rendered is generated by an application upon a remote system which is accessed via a network, such as Network 100, through a remote session employing a virtual machine.

Referring to FIG. 12A there is depicted an exemplary first image 1200A of multiple keystroke input for multiple discrete actions with respect to a screen displayed to a user according to an embodiment of the invention. As depicted in first image 1200A a GUI is displayed to the user in conjunction with a softboard 1250. Displayed within the GUI, but not identified for clarity, are a plurality of elements, in this instance silhouettes of aircraft, wherein first to fourth keystrokes 1210 to 1240 are triggered concurrently (or within a time frame less than that associated with sequential keystrokes) by the user, as depicted in second image 1200B, making multiple concurrent keystrokes upon the physical keyboard 1260 to which the softboard 1250 is associated. Accordingly, as depicted:
First keystroke 1210 is associated with the user selecting the “1” key;
Second keystroke 1220 is associated with the user selecting the “E” key;
Third keystroke 1230 is associated with the user selecting the “F” key; and
Fourth keystroke 1240 is associated with the user selecting the “N” key.

Accordingly, a user can perform multiple concurrent actions within an application such as a game, for example, or within a search/web browser, etc. to select multiple elements concurrently without requiring additional keystrokes. The fact that the GUI actions are concurrent (or plesiochronous) is a major advantage over traditional pointing devices such as the mouse which only allow actions to be performed serially. Therefore, in a video game such as the one from FIG. 12A, acting upon the four airplanes concurrently would not be possible with prior art. In some embodiments some keys may be disabled or associated with a special action, e.g. the SPACEBAR, due to their mapped size within the GUI 1250.

Referring to FIG. 12B there is depicted an exemplary first image 1200C of multiple keystroke input for multiple discrete actions with respect to a screen displayed to a user according to an embodiment of the invention. As depicted in first image 1200C a GUI is displayed to the user in conjunction with a softboard 1250. Displayed within the GUI, but not identified for clarity, are a plurality of elements, in this instance icon such as software icons, configuration icons, etc. wherein in common with the embodiments of the invention described and depicted with respect to FIG. 8A the icons have been mapped to specific keys such that no key is associated with two or more icons. Accordingly, fifth and sixth events 1270 and 1280 are triggered concurrently by the user, as depicted in fourth image 1200D, making multiple concurrent keystrokes upon the physical keyboard 1260 to which the softboard 1250 is associated. Accordingly, as depicted:
Fifth event 1270 is associated with the user selecting the “SHIFT” key and accessing the settings of the system; and
Sixth event 1280 is associated with the user selecting the “CTRL” key and toggling the sound of the system on or off according to the previous state.

Accordingly, a user can perform multiple concurrent actions with respect to the system and applications. In some embodiments some keys may be disabled or associated to a special action, e.g. the SPACEBAR, due to their mapped size within the GUI 1250.

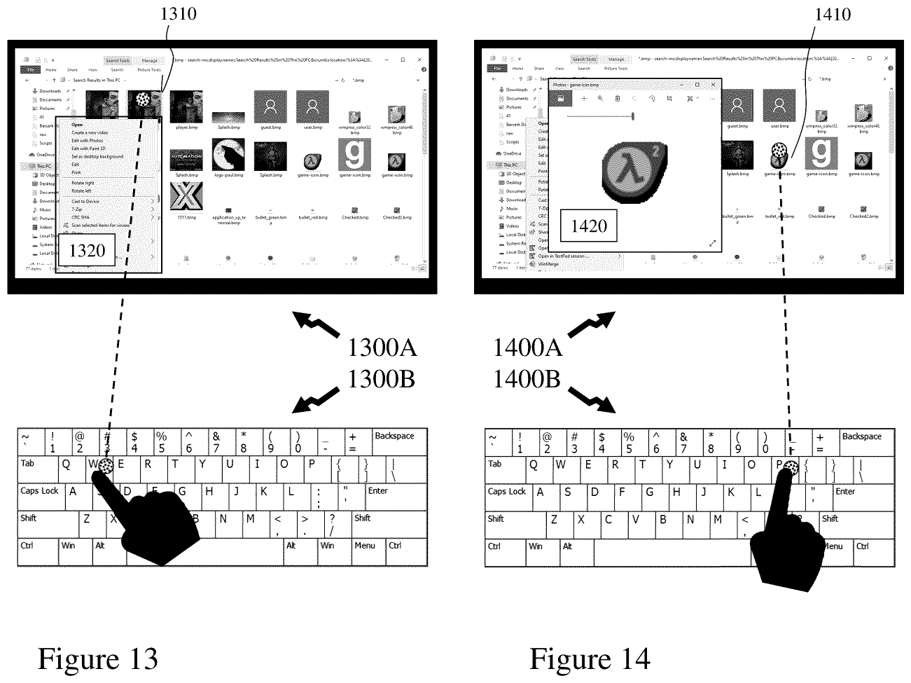

Referring to FIG. 13 there are depicted first and second images 1300A and 1300B respectively relating to an exemplary user action triggered by an action with respect to a keyboard mapped to the screen according to an embodiment of the invention. For the sake of clarity, a softboard has not been displayed within first image 1300A. In the example depicted in FIG. 13 the user as depicted in second image 1300B selects the W key and holds it down, performing what is referred to as a “long press” or “long click” which is recognized by the application associated with the window associated with that region of the screen/GUI to which the W key is mapped. Accordingly, as this overlapped an icon 1310 then the application identifies the “long press” as a command to open a context menu 1320 associated with the icon 1310 as defined by the application.

Referring to FIG. 14 there are depicted first and second images 1400A and 1400B respectively relating to an exemplary user action triggered by an action with respect to a keyboard mapped to the screen according to an embodiment of the invention. For the sake of clarity, a softboard has not been displayed within first image 1400A. In the example depicted in FIG. 14 the user as depicted in second image 1400B selects the P key and performs two key presses within a predetermined period of time, performing what is referred to as a “double click” which is recognized by the application associated with the window associated with that region of the screen/GUI to which the P key is mapped. Accordingly, as this overlapped an icon 1410 then the application identifies the “double click” as a command to open a window 1340 associated with the icon 1410 as defined by the application.

It would be evident that within other embodiments of the invention described and depicted in respect of FIGS. 13 and 14 that “long presses” and/or “double clicks” may trigger other actions according to the application to which they are associated. Optionally, within other embodiments more complex key actions may trigger other actions, e.g. a triple click, a short press with long press, etc.

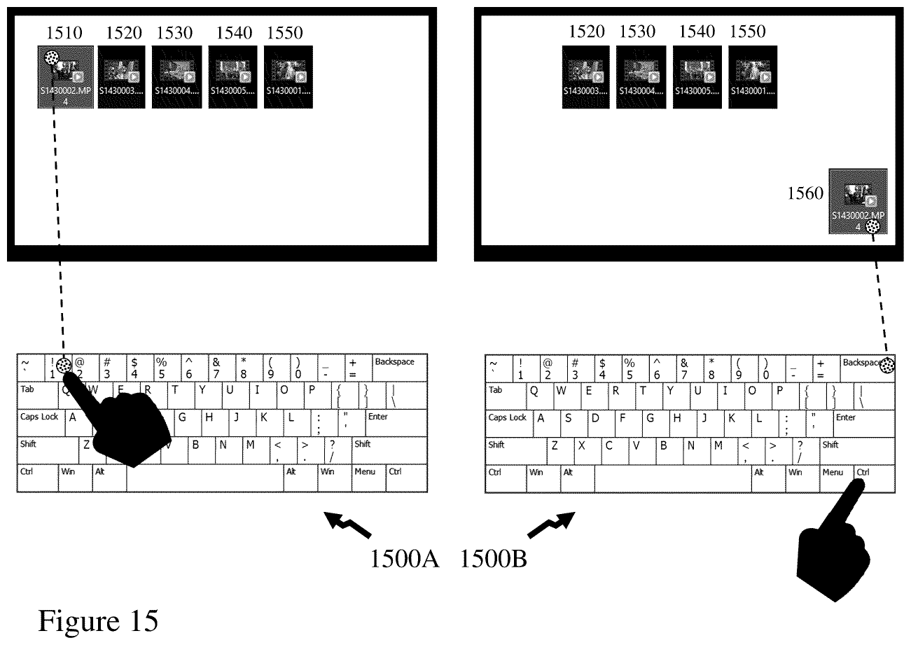

Referring to FIG. 15 there is depicted an exemplary user action triggered by actions with respect to a keyboard mapped to the screen according to an embodiment of the invention. For the sake of clarity, a softboard has not been displayed within first image 1500A. In the example depicted in FIG. 15 the user as depicted selects the 1 key and holds it down, performing what is referred to as a “long press” or “long click” which is recognized by the application associated with the window associated with that region of the screen/GUI to which the 1 key is mapped. The user then makes a “standard press” or “single click” upon a second key, the CTRL key as depicted in second image 1500B. This sequence performing the equivalent of a “drag-and-drop” as known in the art with pointing devices. Accordingly, the icon 1510 of the first to fifth icons 1510 to 1550 respectively is selected and moved from the top left in first image 1500A to the bottom left as sixth icon 1560 in second image 1500B. Optionally, such actions of a “long press”/“single click” may provide a copy-and-paste function wherein the paste action is performed within the mapped region of the keyboard rather than within a predetermined distance from the original copied element as with some applications such as Microsoft™ PowerPoint thereby reducing further user manipulations as the pasted object is already within a desired region of the GUI rather than the original region of the GUI.

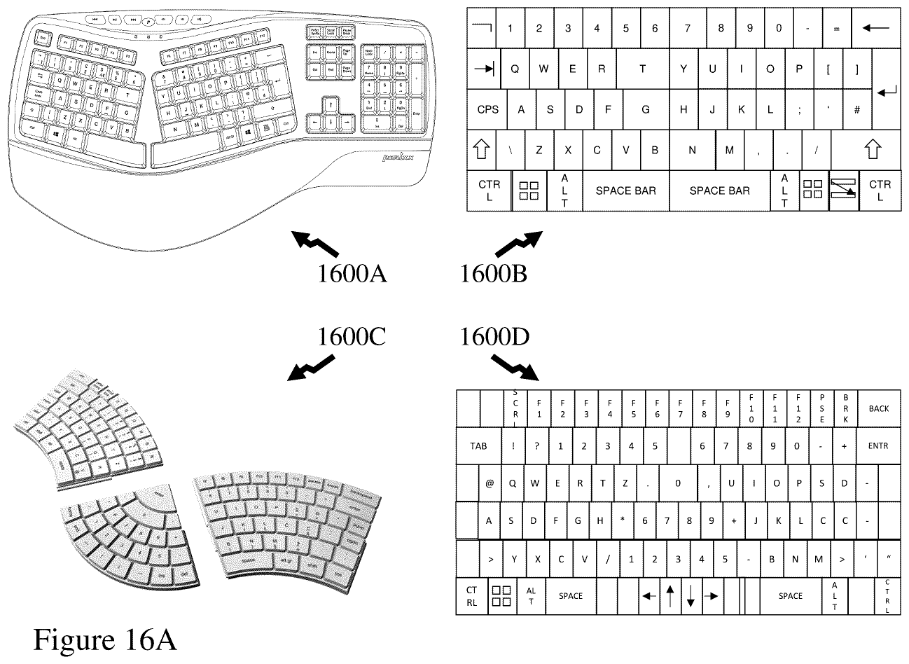

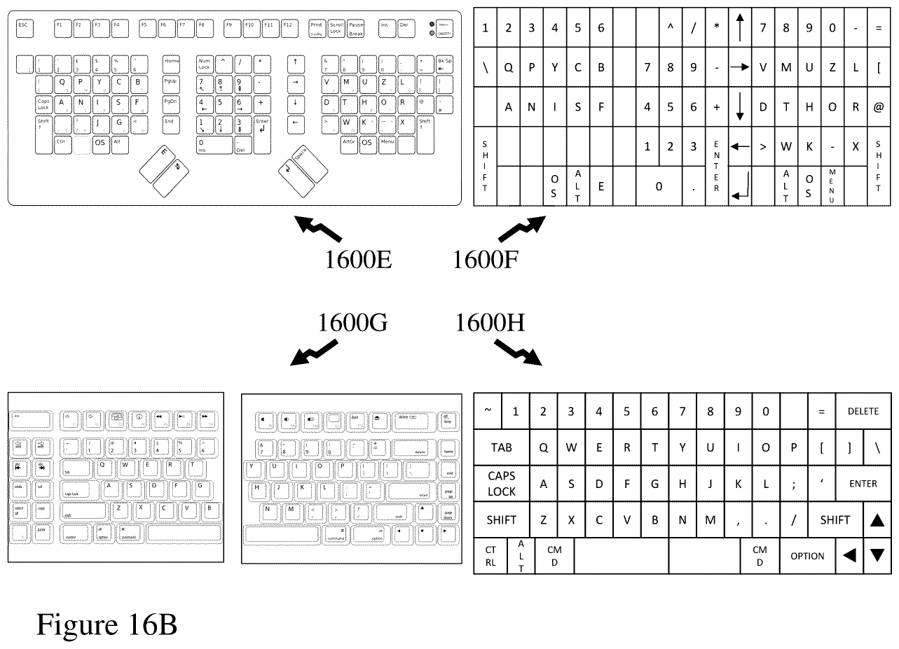

Referring to FIGS. 16A and 16B there are first to eighth images 1600A to 1600H of exemplary non-standard keyboards with their GUI mappings where the non-standard keyboards can be employed as an input interface according to embodiments of the invention by mapping the keyboard to the displayed image on the screen in dependence upon a softboard associated with the keyboard in use. Accordingly, there are depicted:
First image 1600A representing a first type of ergonomic keyboard;
Second image 1600B representing an exemplary keyboard overlay to a GUI for mapping the first type of ergonomic keyboard in first image 1600A to the GUI;
Third image 1600C representing a second type of ergonomic keyboard;
Fourth image 1600D representing an exemplary keyboard overlay to a GUI for mapping the second type of ergonomic keyboard in third image 1600C to the GUI;
Fifth image 1600E representing a third ergonomic keyboard;
Sixth image 1600F representing an exemplary keyboard overlay to a GUI for mapping the third type of ergonomic keyboard in fifth image 1600E to the GUI;
Seventh image 1600F representing a split keyboard comprising multiple elements; and
Eighth image 1600G representing an exemplary keyboard overlay to a GUI for mapping the split keyboard in seventh image 1600E to the GUI.

Within second, fourth, sixth and eighth images 1600B, 1600D, 1600F and 1600H the text labels for some keys have been omitted or abbreviated relative to the text upon the physical keyboard due to the limitations of font size, etc. However, the inventor believes that sufficient keys are identified for each keyboard layout to allow one of skill to understand the mapping applied.

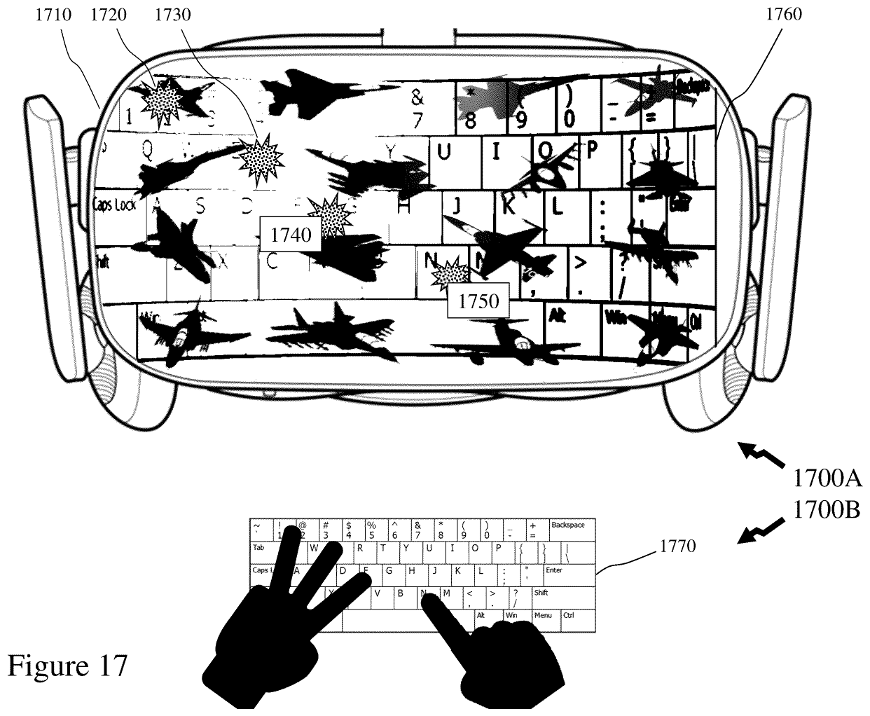

Now referring to FIGS. 17 to 20 there are depicted exemplary mappings of a screen displayed to a user upon a head mounted display to a physical or virtual keyboard allowing the user to employ the keyboard as an input interface according to an embodiment of the invention. Within the preceding descriptions with respect to FIGS. 4A to 16B the display whilst not explicitly stated as being such may have presented in a manner that the reader of the specification may have considered them to be a display forming part of a PED or FED. However, amongst wearable devices as a class of PEDs head mounted displays (HMDs) represent another class of devices where the user is rendered content. Whilst most HMDs have been directed to gaming applications others are directed to vision augmentation for users with vision defects or general users who are mobile as with Epson™ Moverio, Lenovo™ ThinkReality, Snap™ Spectacles AR, and Microsoft™ Hololens 2.

Referring to FIG. 17 there are depicted first and second images 1700A and 1700B for user playing a game upon an HMD 1710 in a similar manner as that described and depicted in FIG. 12A. Accordingly, as depicted the user is employing a keyboard 1770 to make several concurrent key selections resulting in first to fourth strikes 1720 to 1750 within the game where the game image projected via the HMD 1710 is overlaid with softboard 1760 which presents the mapping of keyboard 1770 keys to the game image.

It would be evident that within embodiments of the invention the softboard may be dynamically configured according to the image presented upon the HMD 1710 or as described above in respect of other embodiments of the invention. It would also be evident that the keyboard allows a user to perform gaming actions such as first strike 1720 which is in the periphery of their field of view, while prior art would require the user to face a target or use a pointing device to aim at said target. However, it would evident that within other software applications rendering content to the user that the user may be able to perform other functions concurrently with multiple keys such as moving, copying, deleting, pasting, drawing etc.

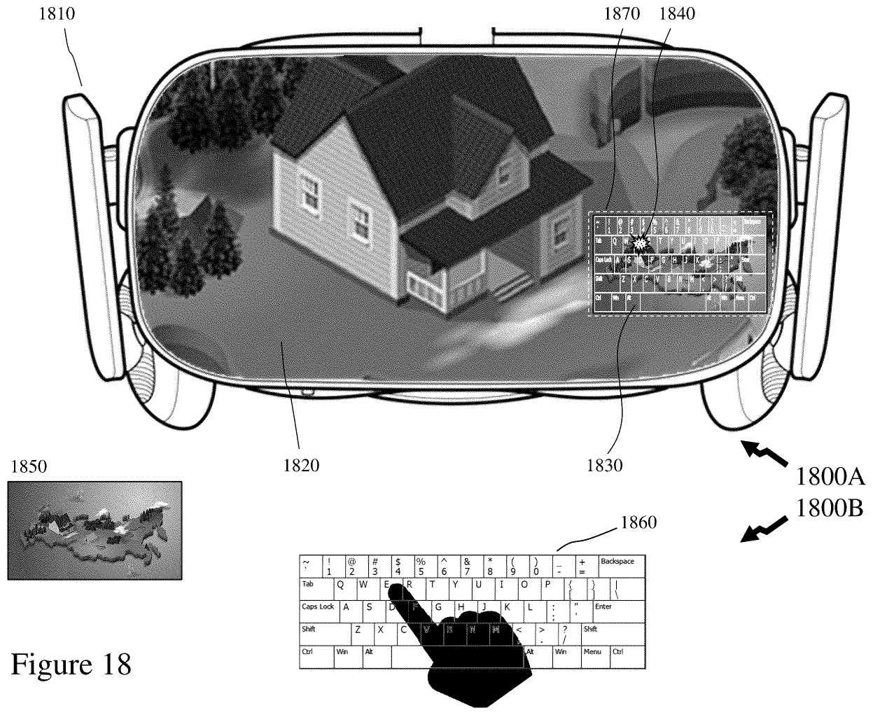

Alternatively, the softboard can be displayed over part of the image rendered to the user. For example, as depicted in FIG. 18 in first and second images 1800A and 1800B the user is using an HMD 1810 within which a first image 1820 is presented together with a second image 1870 is presented upon which is overlaid softboard 1830 such that user actions upon the physical keyboard 1860 are associated with the second image 1870 through the mapping of the softboard to the second image 1870. In the example shown, the second image 1870 is a view of an environment (e.g., an island with a mapping application, game etc.) where the user's keyboard entries through the softboard 1830 result in the view changing to that depicted in first image 1820 (i.e., the region of the environment depicted in second image 1820 associated with the user's keyboard selection). Inset 1850 depicts the environment discretely rather than overlaid to the first image 1820 or overlaid by the softboard 1830. Accordingly, for example, the user entry “E” upon keyboard 1860 results in selection of the region 1840 (commonly called the “minimap”) in the second image 1860 being selected and the image rendered to the user switching to that shown in first image 1820. It would be evident that other applications may exploit the softboard in other modes, such as for example, insert 1850 upon which the softboard is overlaid may be a directory listing, a GUI of an operating system, a navigation GUI of a software application, etc. This scenario is an example of what is commonly called a “teleport” or “teletransportation” action. Prior art would require using a pointing device to select the location to teleport to, which is slow, or using a limited number of buttons on gaming controllers.

The softboard may be statically defined within the image upon the display or it may be dynamically defined, such that for example, if the user scales a window to which a softboard is associated. Alternatively, a softboard may be automatically associated and dimensioned according to a particular window brought into focus within a GUI, e.g. by a user action with respect to the window or as a result of an action of a software application in execution associated with the window.

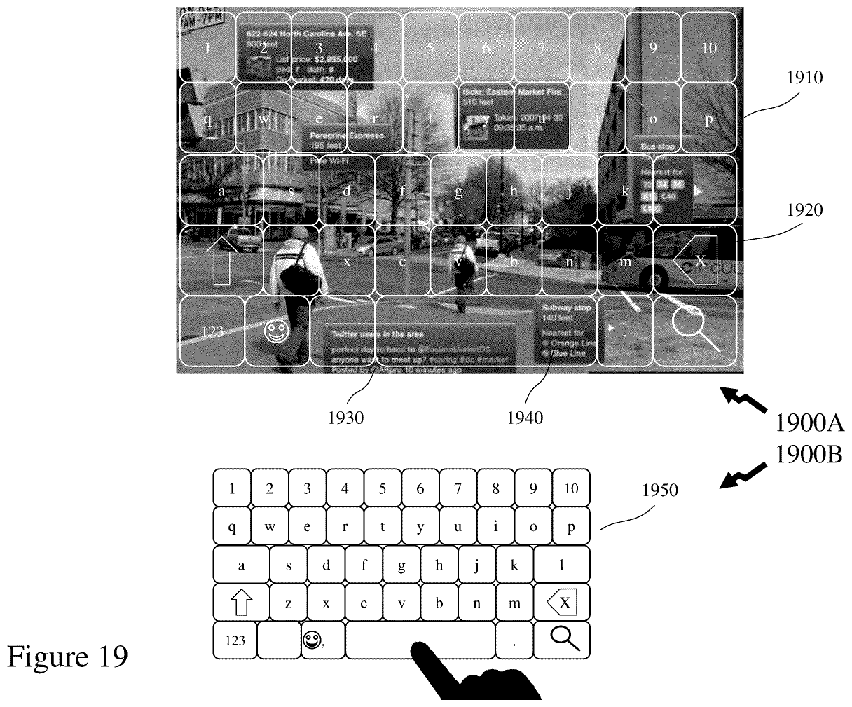

How referring to FIG. 19 there are depicted first and second images 1900A and 1900B of an embodiment of the invention. Within first image 1900A is depicted field of view (FOV) 1910 of a user presented upon an HMD providing the user with augmented reality wherein their real world FOV is viewed but with additional content rendered by the HMD, such as first additional rendered content (ARC) 1930 and second ARC 1940 respectively. In this instance the user is walking within a downtown environment and accordingly their HMD is associated with a wearable device or a PED such as their smartphone. In the example shown the HMD is paired with the user's smartphone and accordingly the softboard 1920 rendered to the user is the default keyboard of their smartphone which may be a physical keyboard or may be a virtual keyboard implemented upon a touch screen display of the smartphone. Accordingly, the keyboard 1950 depicted in second image 1900B is the default keyboard of the PED. The user may configure their PED such that the default keyboard is another keyboard either for all applications or for a specific application associated with capturing the keyboard content when the user/PED are working solely with the FOV 1910 and its additional ARCs.

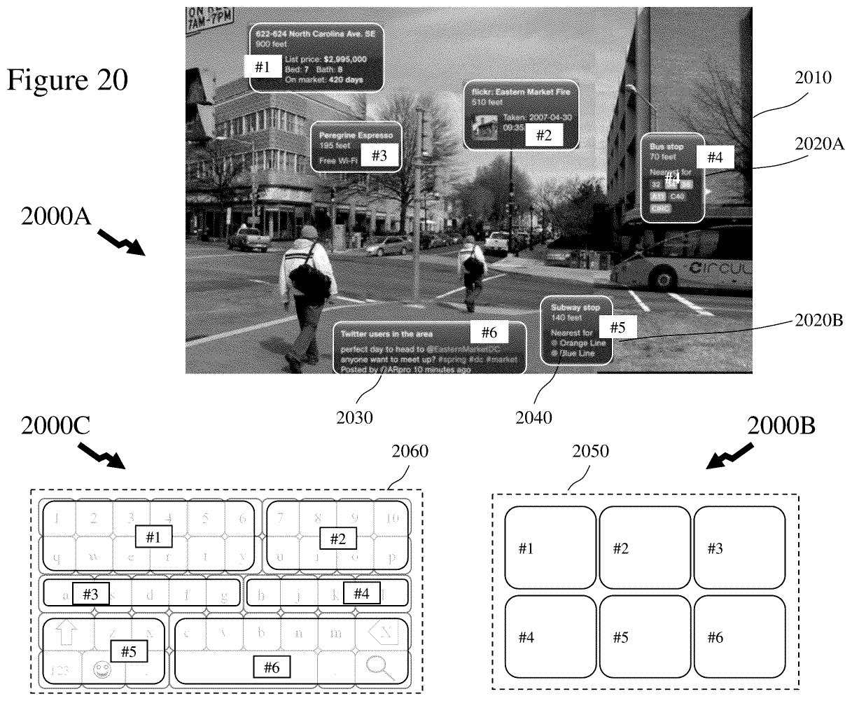

Within FIG. 20 this concept is extended to the dynamic generation of a keyboard upon the PED in dependence upon the ARCs within the FOV 1910. Accordingly, in first image 2000A FOV 2010 as with FIG. 19 depicts a field of view of a user of a HMD within an urban environment with six ARCs presented, although only two are identified as first and second ARCs 2030 and 2040 respectively. The softboard now comprises a series of discrete elements (softkeys) which are aligned to and sized according to the ARCs such as first and second softkeys 2020A and 2020B. The keyboard 2050 depicted in second image 2000B now comprising 6 keys corresponding to the six ARCs within the FOV 2010 rendered to the user.

Within the exemplary embodiment of the invention the ARCs (#1-#6) are mapped to the keys of the keyboard 2050 based upon their vertical position within the FOV 2010. However, it would be evident that other methods of associating ARCs with keys of the keyboard may be employed such as the order in which the ARCs are generated and rendered, etc. as the ARCs are expected to change and adapt according to the external environment, alerts, alarms, etc.

Optionally, the size of the keys within the keyboard 2050 may be scaled according to the size of the ARCs.

Optionally, the size of the keys within the keyboard 2050 may be scaled according to a priority of the ARC, e.g. ARCs for alarms have highest priority, ARCs for alerts having second highest priority, transport related ARCs third priority, social media posts fourth priority and informational ARCs lowest priority (e.g. the one defining the building in FIG. 20 as “622-624 North Carolina Ave. SE”).

Optionally, some ARCs may not have keys of the keyboard associated with them. For example, ARCs relating to navigation may be displayed but not associated with a key as there is no user action associated with them.

Within first image 2000A the softboard for the different ARCs has been suppressed either based upon a user preference, a user setting, or a software decision in order to avoid excessive clutter to the user although it would be evident that the softboard may be displayed to the user. In instances that the softboard is not displayed then the HMD and associated software may upon detecting the user's touching a touch sensitive display render the softboard temporarily.

Alternatively, the HMD may temporarily overlay a “ghost” or low contrast image of the softboard to the user with an indication of where they are currently touching the touch sensitive interface where a user input is defined by the user exceeding a predetermined pressure on the interface or touching, releasing, touching harder so that the initial user's motions to orientate their finger or a pointer on the interface are not taken as input actions.

Alternatively, if the HMD determines the user has now brought the PED into view it may maintain displaying the ARCs for a predetermined period of time.

Optionally, as depicted with keyboard 2060 in third image 2060 in FIG. 20 each softboard key may be associated with multiple keys of the virtual keyboard (or a physical keyboard) wherein the area of a softboard key is proportional, with constraints based upon keys depicted and their sizes etc., to the area of the respective ARC within the image displayed to the user. Whilst in third image 2000C the softboard keys are depicted in a “sequential” order however it would be evident that other association schemes may be employed such as their relative positions being defined by the positions of their associated ARCs within the image or that their size may be established in dependence upon a priority associated with them.

Optionally, the softboard may not overlap some portions of the keyboard (virtual or physical) as the keys for this have defined functions that are to maintained as accessible under all scenarios, e.g. software navigation buttons or functions etc.

Within FIGS. 4A to 20 it would be evident to one of skill in the art that the keyboards depicted are what are commonly referred to as QWERTY (or English) keyboards. However, it would be evident that the embodiments of the invention may also be employed with keyboards within other keyboard categories including, but not limited to, Dvorak, Colemak, AZERTY, Arabic, and Thai. Further it would be evident that the embodiments of the invention may also be employed with alternate language keyboard layouts for a keyboard category including, but not limited to, QWERTY French Canadian and Chinese. It would be evident that in embodiments of the invention wherein a representation of the keyboard is rendered upon the display to aid the user that this may be within embodiments of the invention solely physical outlines of the keys of the keyboard or it may within other embodiments of the invention text may be rendered identifying the keys which would then be based upon the keyboard type. Such that the rendered image match those upon the physical keyboard. Optionally, if the user makes their own labelling on a keyboard then an image of this may be acquired and employed for rendering upon the display as the overlay image.

It would also be evident to one of skill in the art that software applications, particularly operating systems, allow for a user to make language selections such that the keyboard's key layout is different to the physical keyboard. For example, Windows 10 offers over 90 options for a standard QWERTY keyboard including, but not limited to, Japanese, Maori, Inuktitut, US Dvorak for Left Hand, US Dvorak for Right Hand and Scottish Gaelic. Accordingly, such keyboard options are not visible to a user viewing the system but become evident when a user types. The embodiments of the invention described and depicted with respect to FIGS. 4A to 20 ignore such configuration aspects of the overall system so that there is a discrete mapping of the physical keys of the physical keyboard to regions of the display(s). Optionally, within some embodiments of the invention multiple softboards to reflect the different language selections may be employed although within other embodiments of the invention a single softboard may be associated within a specific physical keyboard layout independent of the option(s) added by the user through the operating system, for example.

Within embodiments of the invention a soft keyboard (softboard) has been described as being rendered to a user as an overlay to a software application in execution either upon the same electronic device the user is executing the software application upon or accessing the software application from via a network upon a remote system. The softboard being established and employed as described above is established via template in dependence upon the physical keyboard associated with the electronic device. However, within other embodiments of the invention the template may be established in dependence upon the physical keyboard and the software application in execution. For example, the template may be different when the user's employing a gaming application versus a document management system or a desktop, for example. Within other embodiments of the invention the template may be established in dependence upon the physical keyboard and the display upon which the GUI is rendered. For example, a full mapping may be employed for displays associated with specific PEDs and/or FEDs whilst a partial mapping may be applied for specific wearable devices and other specific PEDs. This may be defined in dependence, for example, upon size of the display relative to a user's finger.

Within embodiments of the invention the template may be installed upon the user installing the keyboard via a storage medium supplied within the keyboard or with the keyboard. In other embodiments of the invention the template may be installed upon the user installing the keyboard based upon the template being retrieved from a remote server. In other embodiments of the invention the template may be automatically retrieved from a remote server based upon the electronic device determining an association of the physical keyboard with the electronic device is being made or possible. Alternatively, within other embodiments of the invention the user may select and download a template from a website accessed via a web browser and a network. Alternatively, within other embodiments of the invention the user may access a remote application and/or website via a network to create a custom template. Alternatively, the software can allow the user to create his own template from scratch or to use an existing template as the starting point to create a new one, or even customize an existing template.

Whilst within the embodiments described and depicted above the embodiments have been described and depicted with respect to the text portion of a keyboard it would be apparent to one of skill in the art that numeric keyboards or numerical keyboard portions of a keyboard may also be employed within other embodiments of the invention. For example, a template may be mapped to a keyboard with external numeric keypad as well to keyboards with integral keypads.

Embodiments of the invention employ a keyboard, normally employed for entering character-based content, as an input pointing device for selecting GUI elements and performing actions with them. As will become evident with respect to embodiments of the invention described and depicted with respect to FIGS. 4 to 16, the keyboard, or a subset of the keyboard, can be mapped to a full screen, a subset of a screen, multiple screens, etc. If it is mapped to a subset of a screen then the subset may be statically defined or it may be dynamically defined such as automatically based upon a context of the GUI elements, system, etc. or manually defined by the user. Within other embodiments of the invention software in execution upon the device may map the GUI elements to a softboard established in dependence upon the keyboard. Within other embodiments of the invention multiple keyboards may be employed to map to a single screen or to multiple screens.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof. For a software implementation, the algorithms may be implemented for example in the operating system, within software “drivers”, within applications, in virtual computer software (virtualization, remote desktop software, KVM), etc.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g. software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A system comprising:
a display for rendering a graphical user interface (GUI) to a user;
a keyboard for receiving user inputs;
a microprocessor coupled to the display, the keyboard, and a non-transitory memory storing computer executable instructions for execution by the microprocessor; wherein
the computer executable instructions when executed by the microprocessor configure the microprocessor to execute a process comprising the steps of:
establish an identity of the keyboard;
retrieve a template associated with the identity of the keyboard, the template comprising a plurality of keyboard regions wherein each keyboard region of the plurality of keyboard regions is associated with a predetermined key or button of the keyboard;
map each keyboard region of the plurality of keyboard regions to a screen portion of a plurality of screen portions, each screen portion of the plurality of screen portions associated with a predetermined portion of a GUI to be rendered upon the display to the user;
establish content to be rendered within the GUI, the content associated with a software application which is either in execution upon the system or is in execution remotely through a web browser;
render the content upon the display;
detect a user action with respect to a key or button of the keyboard;
perform an action with respect to a predetermined screen portion of the plurality of screen portions in dependence upon the key or button to which the user action relates and the template; wherein
the action is established in dependence upon the key or button to which the user action relates and the software application.

2. The system according to claim 1, wherein
the user action is one of a plurality of concurrent user actions, each user action of the plurality of user actions being with respect to a different key or button of the keyboard; and
the system performs multiple actions, each action associated with a user action of the plurality of concurrent user actions.

3. The system according to claim 1, wherein
the template is rendered as a part of the GUI.

4. The system according to claim 1, wherein
the template is rendered within only a portion of the GUI; and
the portion of the GUI is associated with either the software application in execution or the web browser.

5. The system according to claim 1, wherein
the template is rendered over the GUI; and
different portions of the template overlay different application windows rendered within the GUI.

6. The system according to claim 1, wherein
the template is rendered over the GUI;
different portions of the template overlay different application windows rendered within the GUI;
the user action is one of a plurality of concurrent user actions, each user action of the plurality of user actions being with respect to a different key or button of the keyboard; and
the system performs multiple actions, each action associated with a user action of the plurality of concurrent user actions and an application window over which the template is overlaid.

7. The system according to claim 1, wherein
the plurality of regions of the template are rendered with a common size upon the GUI.

8. The system according to claim 1, wherein
the plurality of regions of the template are of an identical size independent of the actual physical size of the associate key or button of the keyboard.

9. The system according to claim 1, wherein
the plurality of regions are re-mapped such that the plurality of regions are not spatially the same as the arrangement of the keys or buttons on the keyboard.

10. The system according to claim 1, wherein
elements of the GUI are re-mapped when the template is invoked such that each region of the plurality of regions is uniquely associated with an element of the GUI.

11. A system comprising:
a display for rendering a graphical user interface (GUI) to a user forming part of an electronic device;
a keyboard for receiving user inputs where the keyboard is rendered upon a touch sensitive display (another display) forming part of another electronic device;
a microprocessor coupled to the display, the keyboard, and a non-transitory memory storing computer executable instructions for execution by the microprocessor; wherein
the computer executable instructions when executed by the microprocessor configure the microprocessor to execute a process comprising the steps of:
establish content to be rendered to a user within a GUI upon the display, the content associated with a software application which is either in execution upon at least one of the electronic device, the another electronic device and a remote application executing upon a remote server accessed through a web browser;
establish a region of the content;
establish a template, the template comprising a plurality of keyboard regions wherein each keyboard region of the plurality of keyboard regions is associated with a predetermined key or button of the keyboard;
map each keyboard region of the plurality of keyboard regions to a screen portion of a plurality of screen portions, each screen portion of the plurality of screen portions associated with a predetermined portion of a GUI;
render the template upon the display as an overlay to the established region of the content;
render the template upon the another display;
detect a user action with respect to a keyboard region of the plurality of keyboard regions of the keyboard;
perform an action with respect to a predetermined screen portion of the plurality of screen portions in dependence upon the keyboard region of the plurality of keyboard regions to which the user action relates; and
the action is established in dependence upon the keyboard region of the plurality of keyboard regions to which the user action relates and the software application.

12. The system according to claim 11, wherein
the electronic device is a head mounted display (HMD);
the another electronic device is a portable electronic device; and
each screen portion of the plurality of screen portions is an item of additional rendered content (ARC) overlaid to a field of view of the external environment of a user wearing the HMD.

13. The system according to claim 11, wherein
the template is dynamically established in dependence upon the region of the content.

14. The system according to claim 11, wherein
the electronic device is a head mounted display (HMD);
the another electronic device is a portable electronic device;
each screen portion of the plurality of screen portions is an item of additional rendered content (ARC) overlaid to a field of view of the external environment of a user wearing the HMD; and
the template is dynamically established in dependence upon the plurality of screen portions.
